(19) United States
(12) Patent Application Publication
(10) Pub. No.: US 2026/0059533 A1
(43) Pub. Date: Feb. 26, 2026

(54) INFORMATION TRANSMISSION METHOD AND COMMUNICATION APPARATUS

(71) Applicant: HUAWEI TECHNOLOGIES CO., LTD., Shenzhen (CN)

(72) Inventors: Lei Wang, Shenzhen (CN); Xiaoyan Bi, Shanghai (CN); Yisheng Jiang, Shanghai (CN)

(73) Assignee: HUAWEI TECHNOLOGIES CO., LTD., Shenzhen (CN)

(21) Appl. No.: 19/372,185

(22) Filed: Oct. 28, 2025

Related U.S. Application Data
(63) Continuation of application No. PCT/CN2023/096660, filed on May 26, 2023.

(51) Int. Cl. H04W 72/21; H04W 72/044

(52) U.S. Cl. CPC H04W 72/21; H04W 72/044

(57) ABSTRACT

An information transmission method and a communication apparatus are disclosed. A preamble sequence or a physical uplink control channel (PUCCH) sequence is generated by using a product (for example, a Kronecker product) of K vectors, where K is an integer greater than or equal to 2, and a preamble is sent based on the preamble sequence, or uplink control information is sent based on the PUCCH sequence. A quantity of generated preamble sequences or PUCCH sequences can be increased, to satisfy a communication requirement of a system, and improve communication efficiency. For example, for the preamble sequence, a quantity of users using the preamble sequence for access can be increased in a random access process. For the PUCCH sequence, a capability and reliability of transmitting the uplink control information through the PUCCH sequence.

### CROSS-REFERENCE TO RELATED APPLICATIONS

This application is a continuation of International Application No. PCT/CN2023/096660, filed on May 26, 2023, the disclosure of which is hereby incorporated by reference in its entirety.

### TECHNICAL FIELD

This disclosure relates to the communication field, and more specifically, to an information transmission method and a communication apparatus.

### BACKGROUND

In an existing cellular mobile communication system, various sequences need to be used to complete a communication task. For example, in a random access process, a terminal device generates a preamble sequence, then adds a cyclic prefix to obtain a preamble signal (the preamble signal may also be referred to as a preamble), and completes the random access process by using the preamble.

In addition to the preamble sequence, in a new radio (NR) communication system, for example, for a physical uplink control channel (PUCCH), different uplink control information (UCI) may be transmitted (or carried) on the PUCCH (or may also be referred to as a PUCCH sequence), and the PUCCH may be obtained by performing a cyclic shift on the PUCCH sequence.

In a current communication system, there are a large quantity of users, and information needs to be implicitly transmitted through preamble sequence grouping, or uplink control information needs to be transmitted by using a PUCCH sequence. However, because there are a small quantity of preamble sequences and a small quantity of PUCCH sequences, it is difficult to satisfy a communication requirement of the communication system, and communication efficiency is affected.

### SUMMARY

This disclosure provides an information transmission method and a communication apparatus, to increase a quantity of generated preamble sequences or PUCCH sequences, satisfy a communication requirement of a system, and improve communication efficiency.

According to a first aspect, an information transmission method is provided. The method may be performed by a terminal device or by a chip used in the terminal device. The method includes: generating a preamble sequence or a PUCCH sequence by using K vectors, where K is an integer greater than or equal to 2; and sending a preamble based on the preamble sequence, or sending uplink control information based on the PUCCH sequence.

According to the information transmission method provided in the first aspect, a preamble sequence, a PUCCH sequence, or the like is generated by using a product (for example, a Kronecker product) of a plurality of vectors, to increase a quantity of generated preamble sequences or PUCCH sequences, so as to satisfy a communication requirement of a system and improve communication efficiency. For example, for the preamble sequence, a quantity of users using the preamble sequence for access can be increased in a random access process. For the PUCCH sequence, a capability and reliability of transmitting uplink control information through the PUCCH sequence can also be improved.

For example, after obtaining the preamble sequence, the terminal device may add a cyclic prefix to the preamble sequence to obtain the preamble.

For example, after obtaining the PUCCH sequence, the terminal device may perform a cyclic shift on the PUCCH sequence to obtain a PUCCH. The uplink control information is sent on the PUCCH or the PUCCH sequence, or content carried (or transmitted) on the PUCCH or the PUCCH sequence is the uplink control information.

For example, the preamble sequence or the PUCCH sequence may be generated by using a Kronecker product of the K vectors.

In a possible implementation of the first aspect, before generating the preamble sequence by using the K vectors, the method further includes: receiving configuration information, where the configuration information includes a generation parameter of K₁ vectors and a generation parameter of K₂ vector sets; generating the K₁ vectors based on the generation parameter of the K₁ vectors; generating the K₂ vector sets based on the generation parameter of the K₂ vector sets; and selecting one vector from each of the K₂ vector sets to obtain K₂ vectors, where the K vectors include the K₁ vectors and the K₂ vectors. In this implementation, the generation parameter of the K₁ vectors and the generation parameter of the K₂ vector sets are configured through the configuration information, so that efficiency of determining the K vectors by the terminal device can be improved. In addition, overheads of the configuration information are low, and consumption of communication resources is reduced.

For example, the generation parameter of the K₁ vectors and the generation parameter of the K₂ vector sets may alternatively be sent to the terminal device separately through different signaling or indication information. In other words, the generation parameter of the K₁ vectors may be sent to the terminal device through one piece of configuration information, and the generation parameter of the K₂ vectors may be sent to the terminal device through another piece of configuration information.

In a possible implementation of the first aspect, before generating the preamble sequence by using the K vectors, the method further includes: receiving configuration information, where the configuration information includes generation parameters of the K vectors or generation parameters of K vector sets; and generating the K vectors based on the generation parameters of the K vectors; or generating the K vector sets based on the generation parameters of the K vector sets, and selecting one vector from each of the K vector sets to obtain the K vectors. In this implementation, the generation parameters of the K vectors or the generation parameters of the K vector sets are configured through the configuration information, so that efficiency of determining the K vectors by a communication apparatus can be improved. In addition, overheads of the configuration information are low, and consumption of communication resources is reduced.

In a possible implementation of the first aspect, the K vectors include a first group of vectors and/or a second group of vectors; the first group of vectors includes at least one of the K₁ vectors or at least one of the K vectors generated by using the generation parameters of the K vectors; the second group of vectors includes at least one of the K₁ vectors or at least one of the K vectors generated by using the generation parameters of the K vectors; a length of a vector in the first group of vectors is determined based on a frequency domain resource occupied by the preamble; and a length of a vector in the second group of vectors is determined based on a time domain resource occupied by the preamble. In this implementation, in a vector corresponding to a preconfigured generation parameter of the vector, a length of the vector is determined based on a frequency domain resource occupied by a preamble signal, and/or the length of the vector is determined based on a time domain resource occupied by the preamble signal. Therefore, an apparatus receiving the preamble signal may perform time domain offset estimation and/or frequency domain offset estimation by using the vector corresponding to the preconfigured generation parameter of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

In a possible implementation of the first aspect, the length of the vector in the first group of vectors satisfies at least one of the following conditions: the length of each vector in the first group of vectors is a factor of a quantity of subcarriers occupied by the preamble, and a product of the lengths of the vectors in the first group of vectors is the quantity of subcarriers occupied by the preamble; and/or the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble. In this implementation, the first group of vectors is mapped to a frequency domain resource occupied by the preamble, the second group of vectors is mapped to a time domain resource occupied by the preamble, and the first group of vectors and/or the second group of vectors satisfy/satisfies the foregoing conditions. Therefore, this can improve efficiency of mapping the first group of vectors and/or the second group of vectors to a time frequency resource of the preamble. In addition, precision of time domain offset estimation and/or frequency domain offset estimation can be improved.

In a possible implementation of the first aspect, at least one of the generation parameter of the K₁ vectors, the generation parameter of the K₂ vector sets, the generation parameters of the K vectors, or the generation parameters of the K vector sets is determined based on a cell identity (identity, ID). In this implementation, for terminal devices in different cells, the selected or determined K vectors are not completely the same. Further, preamble sequences generated by using products of the K vectors are also different. This can reduce interference between cells and improve quality and efficiency of communication performed by using the preamble.

In a possible implementation of the first aspect, when generating the PUCCH sequence by using the K vectors, the method further includes: receiving configuration information, where the configuration information includes generation parameters of the K vectors, and at least a part of the generation parameters of the K vectors are determined based on the uplink control information; and determining the K vectors based on the generation parameters of the K vectors. In this implementation, efficiency of determining the K vectors by the terminal device can be improved. In addition, overheads of the configuration information are low, and consumption of communication resources is reduced. In addition, a capability and reliability of transmitting the uplink control information through the PUCCH sequence can be improved.

In a possible implementation of the first aspect, sending the preamble based on the preamble sequence or sending the uplink control information based on the PUCCH sequence includes: performing a cyclic shift on the preamble sequence or the PUCCH sequence to obtain a cyclically shifted preamble sequence or a cyclically shifted PUCCH sequence; and sending the preamble based on the cyclically shifted preamble sequence, or sending the uplink control information based on the cyclically shifted PUCCH sequence. In this implementation, a quantity of available preamble sequences or PUCCH sequences can be further increased, to increase a quantity of generated preamble sequences or PUCCH sequences.

In a possible implementation of the first aspect, the preamble or the uplink control information is sent in an orthogonal frequency division multiplexing OFDM waveform or a discrete Fourier transform-spread orthogonal frequency division multiplexing DFT-s-OFDM waveform. In this implementation, the DFT-s-OFDM waveform is used, so that a PAPR of the preamble signal can be low, thereby improving transmission efficiency of the preamble.

According to a second aspect, an information transmission method is provided. The method may be performed by a network device, or by a chip used in the network device, or by a RAN node. The method includes: receiving a preamble or uplink control information; and determining a preamble sequence or a PUCCH sequence based on the preamble or the uplink control information, where the preamble sequence or the PUCCH sequence is generated by using a product of K vectors, and K is an integer greater than or equal to 2.

According to the method provided in the second aspect, the preamble sequence or the PUCCH sequence is generated by using a product of a plurality of vectors. This can increase a quantity of generated preamble sequences or PUCCH sequences, to satisfy a communication requirement of a system and improve communication efficiency. For example, for the preamble sequence, a quantity of users using the preamble sequence for access can be increased in a random access process. For the PUCCH sequence, a capability and reliability of transmitting uplink control information through the PUCCH sequence can also be improved.

For example, the preamble sequence or the PUCCH sequence may be generated by using a Kronecker product of the K vectors.

It should be understood that the uplink control information is sent on a PUCCH or the PUCCH sequence, or content carried (or transmitted) on the PUCCH or the PUCCH sequence is the uplink control information.

In a possible implementation of the second aspect, before receiving the preamble, the method further includes: sending configuration information, where the configuration information is used to generate the preamble sequence, the configuration information includes a generation parameter of K₁ vectors and a generation parameter of K₂ vector sets, the generation parameter of the K₁ vectors is used to generate the K₁ vectors, the generation parameter of the K₂ vector sets is used to generate the K₂ vector sets, the K₂ vector sets include K₂ vectors, and the K vectors include the K₁ vectors and the K₂ vectors. In this implementation, the generation parameter of the K₁ vectors and the generation parameter of the K₂ vector sets are configured for a terminal device through the configuration information, so that efficiency of determining the K vectors by the terminal device can be improved. In addition, overheads of the configuration information are low, and consumption of communication resources is reduced.

In a possible implementation of the second aspect, before receiving the preamble, the method further includes: sending configuration information, where the configuration information is used to generate the preamble sequence, the configuration information includes generation parameters of the K vectors or generation parameters of K vector sets, the generation parameters of the K vectors are used to generate the K vectors, or the generation parameters of the K vector sets are used to generate the K vector sets and the K vector sets include the K vectors. In this implementation, the generation parameters of the K vectors or the generation parameters of the K vector sets are configured for a terminal device through the configuration information, so that efficiency of determining the K vectors by the terminal device can be improved. In addition, overheads of the configuration information are low, and consumption of communication resources is reduced.

In a possible implementation of the second aspect, the method further includes: decomposing the preamble sequence to obtain the K vectors, where the K vectors include a first group of vectors and/or a second group of vectors; the first group of vectors includes at least one of the K₁ vectors or at least one of the K vectors generated by using the generation parameters of the K vectors; the second group of vectors includes at least one of the K₁ vectors or at least one of the K vectors generated by using the generation parameters of the K vectors; a length of a vector in the first group of vectors is determined based on a frequency domain resource occupied by the preamble; and a length of a vector in the second group of vectors is determined based on a time domain resource occupied by the preamble; determining a time domain offset estimation value based on the first group of vectors, and/or determining a frequency domain offset estimation value based on the second group of vectors; and performing frequency domain offset adjustment and/or time domain offset adjustment on a received signal based on the frequency domain offset estimation value and/or the time domain offset estimation value. In this implementation, in a vector corresponding to a preconfigured generation parameter of the vector, a length of the vector is determined based on a frequency domain resource occupied by a preamble signal, and/or the length of the vector is determined based on a time domain resource occupied by the preamble signal. Therefore, time domain offset estimation and/or frequency domain offset estimation may be performed by using the vector corresponding to the preconfigured generation parameter of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

In a possible implementation of the second aspect, the length of the vector in the first group of vectors satisfies at least one of the following conditions: the length of each vector in the first group of vectors is a factor of a quantity of subcarriers occupied by the preamble, and a product of the lengths of the vectors in the first group of vectors is the quantity of subcarriers occupied by the preamble; and/or the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble. In this implementation, precision of time domain offset estimation and/or frequency domain offset estimation can be improved.

In a possible implementation of the second aspect, at least one of the generation parameter of the K₁ vectors, the generation parameter of the K₂ vector sets, the generation parameters of the K vectors, or the generation parameters of the K vector sets is determined based on a cell identity ID. In this implementation, for terminal devices in different cells, the selected or determined K vectors are not completely the same. Further, preamble sequences generated by using products of the K vectors are also different. This can reduce interference between cells and improve quality and efficiency of communication performed by using the preamble.

In a possible implementation of the second aspect, before receiving the uplink control information, the method further includes: sending configuration information, where the configuration information includes generation parameters of the K vectors, and at least a part of the generation parameters of the K vectors are determined based on the uplink control information; and after determining the PUCCH sequence, the method further includes: decomposing the PUCCH sequence to obtain the K vectors; and detecting the K vectors separately to obtain content transmitted through the uplink control information. In this implementation, efficiency of determining the K vectors by the terminal device can be improved. In addition, overheads of the configuration information are low, and consumption of communication resources is reduced. In addition, a capability and reliability of transmitting the uplink control information through the PUCCH sequence can be improved.

In a possible implementation of the second aspect, the preamble or the uplink control information is received in an OFDM waveform or a DFT-s-OFDM waveform. In this implementation, the DFT-s-OFDM waveform is used, so that a PAPR of the preamble signal can be low, thereby improving transmission efficiency of the preamble.

According to a third aspect, a communication apparatus is provided. The apparatus includes a module or a unit configured to perform each step according to any one of the first aspect or the possible implementations of the first aspect. The module or unit may be a hardware circuit, may be software, or may be implemented by the hardware circuit in combination with the software. The communication apparatus may be a terminal device, or may be an apparatus (for example, a chip, a chip system, or a circuit) in the terminal device or an apparatus that can be used together with the terminal device.

In a possible implementation of the third aspect, the communication apparatus includes a transceiver unit (which may also be referred to as an interface module) and a processing unit (which may also be referred to as a processing module). The processing unit is configured to control the transceiver unit to receive or send a signal. The processing unit is configured to generate a preamble sequence or a PUCCH sequence by using K vectors, where K is an integer greater than or equal to 2. The transceiver unit is configured to: send a preamble based on the preamble sequence, or send uplink control information based on the PUCCH sequence.

According to a fourth aspect, a communication apparatus is provided. The apparatus includes a module or a unit configured to perform each step in any one of the second aspect or the possible implementations of the second aspect. The module or unit may be a hardware circuit, may be software, or may be implemented by the hardware circuit in combination with the software. The communication apparatus may be a network device, or may be an apparatus (for example, a chip, a chip system, or a circuit) in the network device or an apparatus that can be used together with the network device.

In a possible implementation of the fourth aspect, the communication apparatus includes a transceiver unit (which may also be referred to as an interface module) and a processing unit (which may also be referred to as a processing module). The processing unit is configured to control the transceiver unit to receive or send a signal. The transceiver unit is configured to receive a preamble or uplink control information. The processing unit is configured to determine a preamble sequence or a PUCCH sequence based on the preamble or the uplink control information. The preamble sequence or the PUCCH sequence is generated by using a product of K vectors, and K is an integer greater than or equal to 2.

According to a fifth aspect, a communication apparatus is provided. The apparatus includes at least one processor, configured to perform the method according to any one of the first aspect or the possible implementations of the first aspect.

In a possible implementation, the processor executes instructions stored in a memory, to implement the method according to any one of the first aspect or the possible implementations of the first aspect. Optionally, the communication apparatus further includes the memory that stores the instructions. Optionally, the memory and the processor are integrated together or disposed independently.

In a possible implementation, the processor implements the method according to any one of the first aspect or the possible implementations of the first aspect by using a logic circuit of the processor.

In a possible implementation, the communication apparatus further includes a transceiver, configured to receive or send a signal.

According to a sixth aspect, a communication apparatus is provided. The apparatus includes at least one processor, configured to perform the method according to any one of the second aspect or the possible implementations of the second aspect.

In a possible implementation, the processor executes instructions stored in a memory, to implement the method according to any one of the second aspect or the possible implementations of the second aspect. Optionally, the communication apparatus further includes the memory that stores the instructions. Optionally, the memory and the processor are integrated together or disposed independently.

In a possible implementation, the processor implements the method according to any one of the second aspect or the possible implementations of the second aspect by using a logic circuit of the processor.

In a possible implementation, the communication apparatus further includes a transceiver, configured to receive or send a signal.

According to a seventh aspect, a communication apparatus is provided. The apparatus includes at least one processor and an interface circuit. The interface circuit is configured to output a signal and/or input a signal. The at least one processor is configured to perform the method according to any one of the first aspect or the possible implementations of the first aspect.

According to an eighth aspect, a communication apparatus is provided. The apparatus includes at least one processor and an interface circuit. The interface circuit is configured to output a signal and/or input a signal. The at least one processor is configured to perform the method according to any one of the second aspect or the possible implementations of the second aspect.

According to a ninth aspect, a terminal device is provided. The terminal device includes the communication apparatus provided in the third aspect, or the terminal device includes the communication apparatus provided in the fifth aspect, or the terminal device includes the communication apparatus provided in the seventh aspect.

According to a tenth aspect, a network device is provided. The network device includes the communication apparatus provided in the fourth aspect, or the network device includes the communication apparatus provided in the sixth aspect, or the network device includes the communication apparatus provided in the eighth aspect.

According to an eleventh aspect, a computer program product is provided. The computer program product includes a computer program. When the computer program is executed by a processor, the computer program is used to: perform the method according to any one of the first aspect or the possible implementations of the first aspect, or perform the method according to any one of the second aspect or the possible implementations of the second aspect.

According to a twelfth aspect, a computer-readable storage medium is provided. The computer-readable storage medium stores a computer program. When the computer program is executed, the computer program is used to: perform the method according to any one of the first aspect or the possible implementations of the first aspect, or perform the method according to any one of the second aspect or the possible implementations of the second aspect.

According to a thirteenth aspect, a communication system is provided. The communication system includes the foregoing terminal device and the foregoing network device.

According to a fourteenth aspect, a chip is provided. The chip includes a processor, configured to execute a computer program or instructions in a memory, to cause a communication device mounted with the chip to perform the method according to any one of the first aspect or the possible implementations of the first aspect, or perform the method according to any one of the second aspect or the possible implementations of the second aspect.

### BRIEF DESCRIPTION OF DRAWINGS

FIG. 1 is a diagram of an architecture of a communication system applicable to an embodiment of this disclosure;

FIG. 2 is a diagram of an architecture of another communication system applicable to an embodiment of this disclosure;

FIG. 3 is a diagram of an architecture of an access network device according to an embodiment of this disclosure;

FIG. 4 is a schematic flowchart of an information transmission method according to an embodiment of this disclosure;

FIG. 5 is a schematic flowchart of another information transmission method according to an embodiment of this disclosure;

FIG. 6 is a diagram of generating a preamble sequence by using vectors corresponding to a mode 1 to a mode 4 according to an embodiment of this disclosure;

FIG. 7 is a schematic flowchart of another information transmission method according to an embodiment of this disclosure;

FIG. 8 is a diagram of generating a preamble sequence by using vectors corresponding to a mode 1 to a mode 4 according to an embodiment of this disclosure;

FIG. 9 is a schematic flowchart of another information transmission method according to an embodiment of this disclosure;

FIG. 10 is a diagram of generating a preamble sequence by using vectors corresponding to a mode 1 to a mode 5 according to an embodiment of this disclosure;

FIG. 11 is a schematic flowchart of another information transmission method according to an embodiment of this disclosure;

FIG. 12 is a diagram of generating a preamble sequence by using vectors corresponding to a mode 1 to a mode 4 according to an embodiment of this disclosure;

FIG. 13 is a schematic flowchart of another information transmission method according to an embodiment of this disclosure;

FIG. 14 is a schematic block diagram of a communication apparatus according to an embodiment of this disclosure;

FIG. 15 is a schematic block diagram of another communication apparatus according to an embodiment of this disclosure;

FIG. 16 is a schematic block diagram of still another communication apparatus according to an embodiment of this disclosure;

FIG. 17 is a schematic block diagram of another communication apparatus according to an embodiment of this disclosure;

FIG. 18 is a schematic block diagram of a terminal device according to an embodiment of this disclosure; and

FIG. 19 is a schematic block diagram of a network device according to an embodiment of this disclosure.

### DESCRIPTION OF EMBODIMENTS

The following describes technical solutions of this disclosure with reference to accompanying drawings.

In descriptions of embodiments of this disclosure, “/” means “or” unless otherwise specified. For example, A/B may indicate A or B. In this specification, “and/or” merely describes an association relationship between associated objects, and indicates that three relationships may exist. For example, A and/or B may indicate the following three cases: Only A exists, both A and B exist, and only B exists. In addition, in the descriptions of embodiments of this disclosure, “a plurality of” means two or more.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of embodiments, unless otherwise specified, “a plurality of” means two or more.

In embodiments of this disclosure, a terminal device or a network device includes a hardware layer, an operating system layer running above the hardware layer, and an application layer running above the operating system layer. The hardware layer includes hardware such as a central processing unit (CPU), a memory management unit (MMU), and a memory (also referred to as a main memory). The operating system may be any one or more computer operating systems that implement service processing through a process, for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this disclosure is not particularly limited in embodiments of this disclosure, provided that a program that records code of the method provided in embodiments of this disclosure can be run to perform communication according to the method provided in embodiments of this disclosure. For example, the execution body of the method provided in embodiments of this disclosure may be the terminal device or the network device, or a functional module that can invoke and execute the program in the terminal device or the network device.

In addition, aspects or features of this disclosure may be implemented as a method, an apparatus, or a product that uses standard programming and/or engineering technologies. The term “product” used in this disclosure covers a computer program that can be accessed from any computer-readable component, carrier, or medium. For example, a computer-readable medium may include but is not limited to a magnetic storage component (for example, a hard disk, a floppy disk, or a magnetic tape), an optical disc (for example, a compact disc (CD) or a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel and various other media that can store, contain, and/or carry instructions and/or data.

Currently, in a random access process, a terminal device first generates a base sequence based on a Zadoff-Chu sequence (ZC sequence), obtains a preamble sequence after performing a cyclic shift on the base sequence, and adds a cyclic prefix to obtain a preamble signal (or may also be referred to as a preamble). After receiving the preamble signal, a base station completes tasks such as user identification and uplink timing error estimation. Due to interference and a limitation on a quantity of sequences, a quantity of preambles in each cell is limited. In existing 3GPP LTE and NR protocols, a maximum of 64 preambles exist in each cell.

In an existing communication system, a sequence is further used for implicit transmission of a small amount of information. For example, preambles in each cell are first grouped into a group A (Group A) and a group B (Group B). The terminal device usually selects a preamble sequence in the group A. If the terminal device selects a preamble sequence in the group B, it indicates that the terminal device expects the base station to allocate a large quantity of time-frequency resources to a message 3 (Msg3) or a message B (MsgB) in the random access process. In an NR system, in some configurations, the terminal device may alternatively implicitly indicate a random access type (for example, 4-step access or 2-step access) through preamble grouping, or the terminal device may associate different synchronization signal blocks (SSBs) by using a preamble, to feed back corresponding beam information.

In addition to the preamble sequence, in NR, for example, for a PUCCH, a signal transmitted (or carried) on the PUCCH may include different UCI, for example, include a scheduling request (SR), an acknowledgment (ACK), a channel quality indicator (CQI), and the like. In other words, the PUCCH may be used for transmission of a small amount of uplink control information. The PUCCH may be obtained by performing a cyclic shift value on a PUCCH sequence. It should be understood that, in embodiments of this disclosure, “control information transmitted (or carried) on the PUCCH” may also be expressed as “control information transmitted (or carried) on the PUCCH sequence.” The two expressions have a same meaning.

In an existing NR system, a preamble sequence is generated based on a Zadoff-Chu sequence. Based on root sequences of different Zadoff-Chu sequences and different cyclic shifts, a maximum of 64 different preamble sequences can be generated for each cell. In addition, the PUCCH sequence is also generated based on the Zadoff-Chu sequence.

In a manner of generating a preamble sequence and a PUCCH sequence based on a Zadoff-Chu sequence, quantities of generated preamble sequences and PUCCH sequences are limited by a quantity of available roots of the Zadoff-Chu sequence, a quantity of values of a cyclic shift, and sequence detection performance. In the existing manner of generating the preamble sequence and the PUCCH sequence, the quantities of preamble sequences and PUCCH sequences are limited.

In an existing system, because there are a large quantity of users, and information needs to be implicitly transmitted through preamble sequence grouping or uplink control information needs to be transmitted on a PUCCH sequence, in the existing manner of generating the preamble sequence and the PUCCH sequence based on the Zadoff-Chu sequence, quantities of preamble sequences and PUCCH sequences are small. Consequently, it is difficult to satisfy a communication requirement of the system, and communication efficiency is affected.

In view of this, this disclosure provides an information transmission method, to generate a preamble sequence, a PUCCH sequence, or the like by using a product of a plurality of vectors, to increase a quantity of generated preamble sequences or PUCCH sequences, so as to satisfy a communication requirement of a system and improve communication efficiency. For example, for the preamble sequence, a quantity of users using the preamble sequence for access can be increased in a random access process. For the PUCCH sequence, a capability and reliability of transmitting uplink control information through the PUCCH sequence can also be improved.

In the following examples, a Kronecker product of the plurality of vectors is used as an example for description. However, it should be understood that, in another implementation of this disclosure, the preamble sequence or the PUCCH sequence may be generated by using another product of the plurality of vectors. This is not limited herein in this embodiment of this disclosure.

The following briefly describes the Kronecker product among the plurality of vectors.

It should be understood that, in embodiments of this disclosure, the Kronecker product may also be referred to as a tensor (Tensor) product.

Assuming that Ais an m×n matrix:

$$A = [ \begin{matrix}{a}_{11} & … & {a}_{1 n} \\ ⋮ & ⋱ & ⋮ \\ {a}_{m 1} & … & {a}_{m n}\end{matrix} ] ,$$

and B is a p×q matrix, a Kronecker product of A and B is a pm×qn matrix, and a formula of the Kronecker product of A and B is shown in Formula (1):

$$A ⊗ B = [ \begin{matrix}{a}_{11} B & … & {a}_{1 n} B \\ ⋮ & ⋱ & ⋮ \\ {a}_{m 1} B & … & {a}_{m n} B\end{matrix} ] \qquad ( 1 )$$

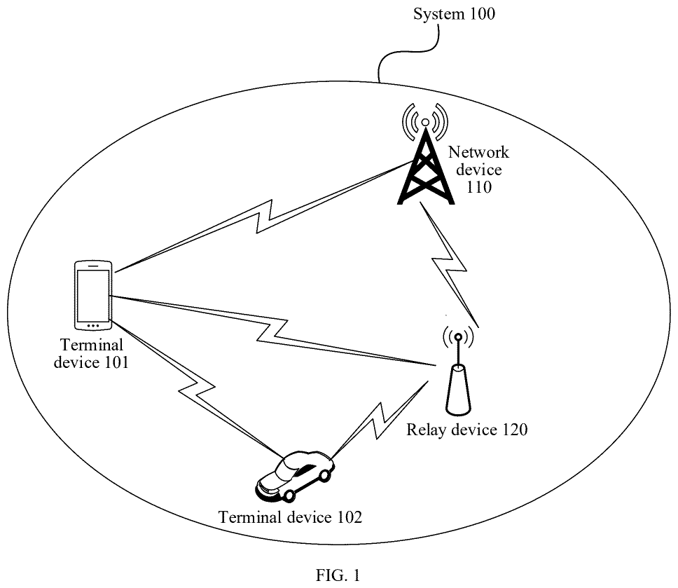

For ease of understanding embodiments of this disclosure, a communication system applicable to embodiments of this disclosure is first briefly described with reference to FIG. 1.

FIG. 1 is a diagram of a communication system 100 applicable to an embodiment of this disclosure. As shown in FIG. 1, the communication system 100 includes four communication devices, for example, a network device 110, a terminal device 101, a terminal device 102, and a relay device 120. A signal and data may be transmitted between the terminal device 101 and the terminal device 102 in a device-to-device (D2D) communication manner, for example, through a sidelink. A signal and data may be transmitted between the network device 110 and each of the terminal device 101 and the terminal device 102 through an uplink or a downlink. For example, uplink or downlink control information and data may be transmitted through a Uu interface. For example, the transmitted signaling or data may include: a preamble and a reference signal; physical layer control information such as downlink control information (DCI) and uplink control information (UCI); control plane (CP) data, for example, a radio resource control (RRC) message; user plane (UP) data; and other information related to a specific scenario or application, for example, related data (for example, gradient information, training data, and a model parameter) generated through artificial intelligence (AI) or machine learning (ML), related data generated by enabling a sensing function or through sensing, or the like.

In the example shown in FIG. 1, the terminal device 101 or the terminal device 102 may perform signal and data transmission with the network device 110 via the relay device 120. For example, the relay device is a network entity that can receive data from the terminal device, the network device, or another relay device and forward the data to another terminal device, network device, or relay device.

In the example shown in FIG. 1, the information transmission method provided in this disclosure may be used in a process of transmitting signaling by using a sequence between the terminal device and the network device, between the terminal device and the relay device, or between the network device and the relay device.

For example, the communication system shown in FIG. 1 may be a 3rd generation partnership project (3GPP)-related cellular system, for example, a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, a 4G or 5G mobile communication system (including standalone networking and non-standalone networking), a new radio (NR) system, a future-oriented evolved system (for example, a 6G mobile communication system), a cloud radio access network (CRAN), or a communication system obtained by integrating two or more of the foregoing systems. This is not limited herein in this embodiment of this disclosure.

In the communication system shown in FIG. 1, signaling or data may be transmitted between different terminal devices, between the terminal device and the network device, between the network device and the relay device, or between the terminal device and the relay device in a dynamic grant manner, or may be transmitted in a grant-free manner, for example, a two-step (2-step) or four-step (4-step) random access process.

For example, in the communication system shown in FIG. 1, a high-frequency transmission scenario may exist between different devices, for example, transmission is performed by using a millimeter wave or a terahertz (THz) wave. Certainly, a low-frequency transmission scenario may alternatively exist between different devices, for example, signaling or data is transmitted by using a wave at a frequency band like 700 MHz, 900 MHz, 2.1 GHz, 2.6 GHz, or 3.5 GHz.

For example, in the communication system shown in FIG. 1, signaling or data may be transmitted between different devices by using a licensed frequency band, or the signaling or the data may be transmitted by using an unlicensed frequency band.

For example, in the communication system shown in FIG. 1, the terminal device may be in a connected state or an active state, or may be in a non-connected (inactive) state or an idle state, or may be in another state other than the foregoing three states. For example, the terminal device does not perform network attachment or does not perform downlink synchronization with a network.

For example, the method provided in embodiments of this disclosure may be further used in a non-terrestrial network (NTN) communication link, for example, a satellite communication link. This is not limited herein in this embodiment of this disclosure.

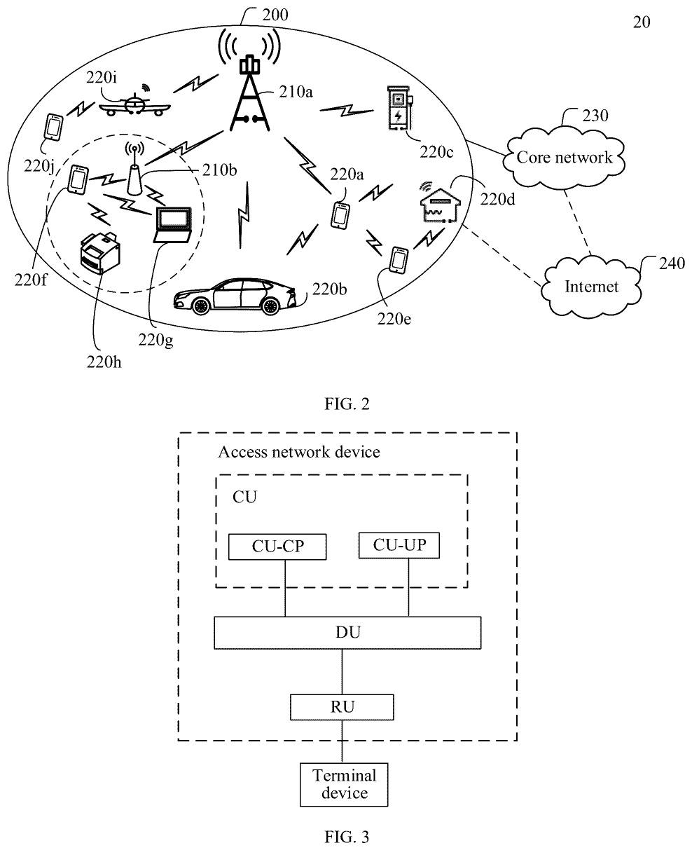

FIG. 2 is a diagram of another communication system 20 applicable to an embodiment of this disclosure. As shown in FIG. 2, the communication system 20 includes a radio access network (RAN) 200, a core network (CN) 230, and an internet 240. The RAN 200 includes at least one RAN node (for example, 210a and 210b in FIG. 2, collectively referred to as 210) and at least one terminal (for example, 220a to 220j in FIG. 2, collectively referred to as 220). The RAN 200 may further include another RAN node, for example, a wireless relay device and/or a wireless backhaul device (not shown in FIG. 2). The terminal 220 is connected to the RAN node 210 in a wireless manner. The RAN node 210 is connected to the core network 230 in a wireless or wired manner. A core network device in the core network 230 and the RAN node 210 in the RAN 200 may be separately different physical devices, or may be a same physical device that integrates a logical function of the core network and a logical function of the radio access network.

The RAN 200 may be a 3GPP-related cellular system, for example, a 4G or 5G mobile communication system, or a future-oriented evolved system (for example, a 6G mobile communication system). The RAN 200 may alternatively be an open access network (open RAN, O-RAN, or ORAN) or a cloud radio access network (CRAN) system. The RAN 200 may alternatively be a communication system that integrates two or more of the foregoing systems.

The RAN node 210 may also be sometimes referred to as an access network device, a RAN entity, an access node, or the like, and is a part of the communication system to help the terminal implement radio access. A plurality of RAN nodes 210 in the communication system 20 may be nodes of a same type, or may be nodes of different types. In some scenarios, roles of the RAN node 210 and the terminal 220 are relative. For example, the network element 220i in FIG. 2 may be a helicopter or an uncrewed aerial vehicle, and may be configured as a mobile base station. For the terminal 220j that accesses the RAN 200 via the network element 220i, the network element 220i is a base station. However, for the base station 210a, the network element 220i is a terminal. The RAN node 210 and the terminal 220 are sometimes both referred to as communication apparatuses. For example, in FIG. 2, the network elements 210a and 210b may be understood as communication apparatuses having a base station function, and the network elements 220a to 220j may be understood as communication apparatuses having a terminal function.

In a possible scenario, the RAN node may be a base station, an evolved NodeB (eNodeB), an access point (AP), a transmission reception point (TRP), a nex-generation NodeB (gNB), a next-generation base station in a 6th generation (6G) mobile communication system, a base station in a future mobile communication system, or the like. The RAN node may be a macro base station (for example, 210a in FIG. 2), a micro base station or an indoor station (for example, 210b in FIG. 2), a relay node or a donor node, or a radio controller in a CRAN scenario. Optionally, the RAN node may alternatively be a server, a wearable device, a vehicle, a vehicle-mounted device, or the like. For example, an access network device in a vehicle to everything (V2X) technology may be a road side unit (RSU). All or a part of functions of the RAN node in this disclosure may alternatively be implemented by using a software function running on hardware, or may be implemented by using an instantiated virtualization function on a platform (for example, a cloud platform). Alternatively, the RAN node in this disclosure may be a logical node, a logical module, or software that can implement all or a part of the functions of the RAN node.

In another possible scenario, the plurality of RAN nodes coordinate to assist the terminal in implementing radio access, and different RAN nodes separately implement a part of functions of the base station. For example, the RAN node may be a central unit (CU), a distributed unit (DU), a CU-control plane (CP), a CU-user plane (UP), a radio unit (RU), or the like. The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this disclosure. Any one of the CU (or the CU-CP and the CU-UP), the DU, and the RU in this disclosure may be implemented by using a software module, a hardware module, or a combination of the software module and the hardware module.

In the example shown in FIG. 2, the information transmission method provided in this disclosure may be used in a process of transmitting signaling by using a sequence between the terminal and the RAN node, between the network element 210a and the network element 210b, and between the terminal and the network element 210b.

For example, FIG. 3 is a diagram of a radio access network RAN. As shown in FIG. 3, an access network device includes one or more CUs, one or more DUs, and one or more radio units (RUs). For clarity, FIG. 3 shows only one CU, one DU, and one RU. The CU is configured to connect to a core network and the one or more DUs. Optionally, the CU may have a part of functions of the core network. The CU may include a CU-CP and a CU-UP.

The CU and the DU may be configured based on protocol layer functions of a wireless network implemented by the CU and the DU. For example, the CU is configured to implement functions of a packet data convergence protocol (PDCP) layer and an upper protocol layer (for example, a radio resource control (RRC) layer and/or a service data adaptation protocol (SDAP) layer). The DU is configured to implement functions of a protocol layer (for example, a radio link control (RLC) layer, a media access control (MAC) layer, and/or a physical (PHY) layer) below the PDCP layer. For another example, the CU is configured to implement a function of a protocol layer (for example, the RRC layer and/or the SDAP layer) above the PDCP layer, and the DU is configured to implement functions of the PDCP layer and a protocol layer below the PDCP layer (for example, the RLC layer, the MAC layer, and/or the PHY layer).

When the CU includes the CU-CP and a CU-UP, the CU-CP is configured to implement a control plane function of the CU, and the CU-UP is configured to implement a user plane function of the CU. For example, when the CU is configured to implement functions of the PDCP layer, the RRC layer, and the SDAP layer, the CU-CP is configured to implement the function of the RRC layer and a control plane function of the PDCP layer, and the CU-UP is configured to implement the function of the SDAP layer and a user plane function of the PDCP layer.

The CU-CP may interact with a network element configured to implement a control plane function in the core network. A network element configured to implement the control plane function in the core network may be an access and mobility function network element, for example, an access and mobility function (AMF) network element in a 5G system. The access and mobility function network element is configured to be responsible for mobility management in a mobile network, for example, location update of a terminal device, network registration of the terminal device, and handover of the terminal device.

The CU-UP may interact with a network element configured to implement a user plane function in the core network. The network element configured to implement the user plane function in the core network, for example, a user plane function (UPF) in the 5G system, is configured to be responsible for forwarding and receiving data in the terminal device.

The foregoing configuration of the CU and the DU is merely an example. Alternatively, functions of the CU and the DU may be configured as needed. For example, the CU or the DU may be configured to have functions of more protocol layers, or the CU or the DU may be configured to have a part of processing functions of the protocol layers. For example, a part of the functions of the RLC layer and a function of a protocol layer above the RLC layer are set on the CU, and a remaining function of the RLC layer and a function of a protocol layer below the RLC layer are set on the DU. For another example, division into functions of the CU or the DU may be performed based on service types or other system requirements. For example, division may be performed based on a delay. A function whose processing time needs to satisfy a small delay requirement is set on the DU, and a function whose processing time does not need to satisfy the delay requirement is set on the CU.

The DU and the RU may cooperate to implement the function of the PHY layer. One DU may be connected to one or more RUs. The functions of the DU and the RU may be configured in a plurality of manners based on a design. For example, the DU is configured to implement a baseband function, and the RU is configured to implement an intermediate radio frequency function. For another example, the DU is configured to implement a higher-layer function of the PHY layer, and the RU is configured to implement a lower-layer function of the PHY layer or implement the lower-layer function and a radio frequency function. The higher-layer function of the physical layer may include a part of the functions of the physical layer, and the part of functions are closer to the MAC layer. The lower-layer function of the physical layer may include another part of the functions of the physical layer, and the part of functions are closer to an intermediate radio frequency side.

The terminal in embodiments of this disclosure may also be referred to as a terminal device, a user equipment (UE), a mobile station, a mobile terminal, or the like. The terminal may be widely used in various scenarios, such as device-to-device (D2D) communication, vehicle to everything (V2X) communication, machine-type communication (MTC), an internet of things (IoT), virtual reality, augmented reality, industrial control, self driving, telemedicine, a smart grid, smart furniture, a smart office, smart wearable, smart transportation, and a smart city. The terminal may be a mobile phone, a tablet computer, a computer with a wireless transceiver function, a wearable device, a vehicle, an uncrewed aerial vehicle, a helicopter, an airplane, a ship, a robot, a robot arm, a smart home device, or the like. A device form of the terminal is not limited in embodiments of this disclosure.

It should be understood that, in embodiments of this disclosure, the “RAN node” may also have different expressions. For example, the “RAN node” may also be referred to as a network device, an access network device, a radio access network device, or the like. Unless otherwise specified, the “network device” is used for expression in this disclosure. The network device is an original expression of an access network device (for example, a base station).

It should be understood that the communication systems shown in FIG. 1 and FIG. 2 are merely examples, and should not constitute any limitation on the communication system applicable to embodiments of this disclosure. For example, the communication system shown in FIG. 1 and/or FIG. 2 may further include more or smaller network nodes, for example, a terminal device or a RAN node. The RAN nodes or the terminal devices included in the communication system shown in FIG. 1 and/or FIG. 2 may be RAN nodes or terminal devices in the foregoing various forms. Details are not shown one by one in the figure in embodiments of this disclosure.

The technical solutions provided in embodiments of this disclosure are described below with reference to specific exemplars.

It should be understood that, in embodiments of this disclosure, the method is described by using an example in which the method is performed by a terminal device and a network device. By way of example and not limitation, the terminal device in this disclosure may alternatively be a chip, a chip system, or a processor that supports the terminal device in implementing the method; and the network device in this disclosure may alternatively be a chip, a chip system, or a processor that supports the network device in implementing the method, or may be a logical node, a logical module, or software that can implement all or a part of functions of the network device.

It should be further understood that, in this disclosure, “sending information to . . . (the terminal device)” may be understood as that a destination end of the information is the terminal, and may include directly or indirectly sending the information to the terminal device; and “receiving information from . . . (the terminal device)” or “receiving information from the terminal device” may be understood as that a source end of the information is the terminal device, and may include directly or indirectly receiving the information from the terminal device. Necessary processing, for example, a format change, may be performed on the information between the source end sending the information and a destination end. However, the destination end can understand valid information from the source end. A similar expression in this disclosure may be understood similarly, and details are not described herein again.

The following examples are described by using a preamble sequence and a PUCCH sequence as examples. However, it should be understood that the method provided in embodiments of this disclosure may be further applied to generate another sequence of uplink information or downlink information, and the sequence is used to obtain the uplink information or the downlink information (an uplink signal or a downlink signal) for transmission.

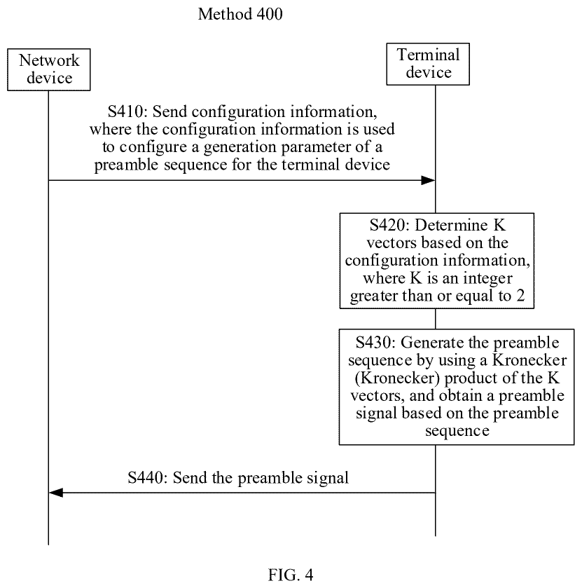

FIG. 4 is a schematic interaction diagram of an information transmission method according to an embodiment of this disclosure. The method 400 may be used in the scenario shown in FIG. 1 or FIG. 2, and certainly may also be used in another communication scenario. This is not limited herein in this embodiment of this disclosure.

As shown in FIG. 4, the method 400 shown in FIG. 4 may include S410 to S440. The following describes each step in the method 400 in detail with reference to FIG. 4.

S410: A network device sends configuration information to a terminal device, where the configuration information is used to configure a generation parameter of a preamble sequence for the terminal device.

Correspondingly, the terminal device receives the configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

For example, the network device or the RAN node may send the configuration information to the terminal device through RRC signaling or a media access control control element (MAC CE). Certainly, in another implementation of this disclosure, the network device may further send the configuration information to the terminal device through other higher layer signaling or physical layer signaling. This is not limited herein in this embodiment of this disclosure.

In some embodiments, the configuration information is used by the terminal device to determine K vectors, and the terminal device may generate or obtain the preamble sequence by using a product of the K vectors, where K is an integer greater than or equal to 2.

Optionally, in a possible implementation, the configuration information may include a generation parameter of K₁ vectors and a generation parameter of K₂ vector sets. A sum of K₁ and K₂ is K, or K includes K₁ and K₂. A generation parameter of each vector may include one or more generation parameters, and a generation parameter of each vector set may include one or more generation parameters. Values of K₁ and K₂ may be the same or different.

For example, assuming that K is equal to 4, that is, the configuration information is used by the terminal device to determine four vectors, the configuration information may include generation parameters of two vectors and generation parameters of two vector sets. The four vectors are respectively vectors corresponding to four modes or dimensions (modes) of a tensor (Tensor), and the four vectors are vectors respectively corresponding to a mode 1 to a mode 4. For example, the configuration information may include generation parameters of vectors corresponding to the mode 1 and the mode 3, and generation parameters of vector sets respectively corresponding to the mode 2 and the mode 4.

Certainly, the configuration information may alternatively include a generation parameter of one vector and generation parameters of three vector sets; or generation parameters of three vectors and a generation parameter of one vector set.

Optionally, in another possible implementation, the configuration information may include generation parameters of K vectors, where K is an integer greater than or equal to 2.

In still another possible implementation, the configuration information may include generation parameters of K vector sets, where K is an integer greater than or equal to 2.

It should be understood that, in embodiments of this disclosure, the generation parameter of the K₁ vectors and the generation parameter of the K₂ vector sets may be sent to the terminal device separately through different signaling or indication information. In other words, the generation parameter of the K₁ vectors may be sent to the terminal device through one piece of configuration information, and the generation parameter of the K₂ vectors may be sent to the terminal device through another piece of configuration information.

Optionally, in this embodiment of this disclosure, the generation parameter of the K₁ vectors and/or the generation parameter of the K₂ vector sets are/is determined based on a cell identity (ID) of the terminal device (or related to the cell ID of the terminal device).

Optionally, in this embodiment of this disclosure, the generation parameters of the K vectors or the generation parameters of the K vector sets are determined based on a cell ID of the terminal device (or related to the cell ID of the terminal device).

S420: After receiving the configuration information, the terminal device determines the K vectors based on the configuration information, where K is an integer greater than or equal to 2.

In a possible implementation, if the configuration information includes the generation parameter of the K₁ vectors and the generation parameter of the K₂ vector sets, and the sum of K₁ and K₂ is K, after receiving the configuration information, the terminal device generates the K₁ vectors based on the generation parameter of the K₁ vectors and the cell ID of the terminal device, generates the K₂ vector sets based on the generation parameter of the K₂ vector sets and the cell ID of the terminal device, and selects one vector from each vector set to obtain K₂ vectors, to obtain or determine the K vectors.

In another possible implementation, if the configuration information includes the generation parameters of the K vectors, after receiving the configuration information, the terminal device generates or determines the K vectors based on the generation parameters of the K vectors and the cell ID of the terminal device.

In still another possible implementation, if the configuration information includes the generation parameters of the K vector sets, after receiving the configuration information, the terminal device generates or determines the K vector sets based on the generation parameters of the K vector sets and the cell ID of the terminal device, and selects one vector from each vector set to obtain the K vectors.

The following describes, with reference to a specific example, a process of generating the K₁ vectors based on the generation parameter of the K₁ vectors and the cell ID of the terminal device.

For example, assuming a generation parameter of one of the K₁ vectors is a generation parameter of an M^{th} vector, the generation parameter of the M^{th} vector configured by the network device may include n generation parameters: A₁, A₂, . . . , and Aₙ. Assuming that the cell ID is Cell ID, and T and F are respectively a time domain parameter and a frequency domain parameter of preamble resource mapping, the M^{th} vector may be obtained in the following manner:

First, a root of a ZC sequence or a root of an m sequence is obtained based on A₁, A₂, . . . , Aₙ, T, and F. Then, the ZC sequence or the m sequence is obtained based on the root of the ZC sequence or the root of the m sequence. A cyclic shift is added to the ZC sequence or the m sequence to obtain a new ZC sequence or a new m sequence. The new ZC sequence or the new m sequence is the obtained M^{th} vector.

If the ZC sequence is used, the root of the ZC sequence may be determined according to Formula (2):

$$Root of the ZC sequence = {f}_{1} ( Cell ID , {A}_{1} , {A}_{2} , … , {A}_{n} , T , F ) \qquad ( 2 )$$

In Formula (2), f₁ is a preset function or a function predefined in a protocol.

A value of the cyclic shift of the ZC sequence may be determined according to Formula (3):

$$Value of the cyclic shift of the ZC sequence = {f}_{2} ( Cell ID , {A}_{1} , {A}_{2} , … , {A}_{n} , T , F ) \qquad ( 3 )$$

In Formula (3), f₂ is a preset function or a function predefined in the protocol.

If the m sequence is used, the root of the m sequence may be determined according to Formula (4):

$$Root of the m sequence = {f}_{3} ( Cell ID , {A}_{1} , {A}_{2} , … , {A}_{n} , T , F ) \qquad ( 4 )$$

In Formula (4), f₃ is a preset function or a function predefined in the protocol.

A value of the cyclic shift of the m sequence may be determined according to Formula (5):

$$Value of the cyclic shift of the m sequence = {f}_{4} ( Cell ID , {A}_{1} , {A}_{2} , … , {A}_{n} , T , F ) \qquad ( 5 )$$

In Formula (5), f₄ is a preset function or a function predefined in the protocol.

It should be understood that the foregoing is merely an example of a process of obtaining a vector based on a generation parameter of the vector and the cell ID. In another implementation of this disclosure, a vector may alternatively be obtained in another manner based on a generation parameter of the vector and the cell ID. This is not limited herein in this embodiment of this disclosure.

Optionally, in this embodiment of this disclosure, the generation parameter of the K₁ vectors and/or the generation parameter of the K₂ vector sets are/is determined based on (or related to) the cell ID of the terminal device. Alternatively, the generation parameters of the K vectors or the generation parameters of the K vector sets are determined based on (or related to) the cell ID of the terminal device. Different cells correspond to different cell IDs. Therefore, for terminal devices in different cells, selected or determined K vectors are not completely the same. Further, preamble sequences generated by using products of the K vectors are also different. This can reduce interference between the cells and improve quality and efficiency of communication.

Optionally, in a possible implementation, after the terminal device obtains the K vector sets or the K₂ vector sets, for any vector set, the terminal device may further perform a cyclic shift on one or more elements (one element is one vector) in the vector set to obtain a new vector. This can increase a quantity of vectors included in the vector set. Then, the terminal device selects one vector from each vector set, to obtain the K vectors or the K₂ vectors. In this manner, a range or a quantity of vectors selected by the terminal device from the vector sets can be increased, and a probability that different terminal devices select different vectors is increased, to reduce a probability of interference or a collision between different terminal devices, and improve quality and efficiency of communication.

For example, it is assumed that the configuration information includes the generation parameters of the vectors corresponding to the mode 1 and the mode 3, and the generation parameters of the vector sets respectively corresponding to the mode 2 and the mode 4. After receiving the configuration information, the terminal device generates the vectors respectively corresponding to the mode 1 and the mode 3 based on the generation parameters of the vectors corresponding to the mode 1 and the mode 3 and the cell ID of the terminal device. The terminal device generates the vector set corresponding to the mode 2 based on the generation parameter of the vector set corresponding to the mode 2 and the cell ID of the terminal device, and randomly selects one vector from the vector set corresponding to the mode 2, to obtain the vector corresponding to the mode 2. The terminal device generates the vector set corresponding to the mode 4 based on the generation parameter of the vector set corresponding to the mode 4 and the cell ID of the terminal device, and randomly selects one vector from the vector set corresponding to the mode 4, to obtain the vector corresponding to the mode 4. In this way, the vectors respectively corresponding to the mode 1 to the mode 4 are obtained. The four vectors are respectively vectors corresponding to the four modes or dimensions (modes) of the tensor (Tensor).

S430: The terminal device generates the preamble sequence by using a Kronecker product of the K vectors, and obtains a preamble signal based on the preamble sequence.

For example, the terminal device may perform Kronecker multiplication on the K vectors to obtain a Kronecker multiplication result of the K vectors, that is, obtain the preamble sequence.

For example, it is assumed that K is equal to 4. The terminal device performs the Kronecker multiplication on the four vectors, that is, performs an operation of mode 4*mode 3*mode 2*mode 1, where “*” represents the Kronecker multiplication, and “mode i” represents a vector corresponding to an i^{th} mode or dimension of the tensor (Tensor), to obtain the preamble sequence.

The terminal device obtains the preamble sequence, and may add a cyclic prefix to the preamble sequence to obtain the preamble signal.

Optionally, the terminal device may further perform a cyclic shift on the generated preamble sequence to obtain a cyclically shifted preamble sequence, and add a cyclic prefix to the cyclically shifted preamble sequence to obtain the preamble signal, so that a quantity of available preamble sequences can be further increased. Optionally, a value of the cyclic shift may be indicated by the network device to the terminal device, or may be predefined in a protocol.

It should be understood that, in this embodiment of this disclosure, in addition to generating the preamble sequence by using the Kronecker product of the K vectors, the preamble sequence may alternatively be generated by using another product of the K vectors. A specific manner of the product of the K vectors is not limited in this disclosure.

Optionally, in this embodiment of this disclosure, in a possible implementation, the terminal device may further perform orthogonal frequency division multiplexing (OFDM) modulation on the generated preamble sequence (or the cyclically shifted preamble sequence), for example, perform a processing process like time-frequency resource mapping, inverse fast Fourier transform (IFFT), or cyclic prefix addition, to obtain the preamble signal, so that the preamble signal can be sent to the network device in an OFDM waveform.

Optionally, in this embodiment of this disclosure, in another possible implementation, the terminal device may further perform discrete Fourier transform (DFT) on the generated preamble sequence (or the cyclically shifted preamble sequence) symbol by symbol (that is, on each OFDM symbol), and perform OFDM modulation (for example, perform a processing process like time-frequency resource mapping, inverse fast Fourier transform (IFFT), or cyclic prefix addition) to obtain the preamble signal, so that the preamble signal can be sent to the network device in a discrete Fourier transform-spread orthogonal frequency division multiplexing (DFT-s-OFDM) waveform. In this way, a peak to average power ratio (PAPR) of the preamble signal may be low, and transmission efficiency of the preamble is improved.

S440: The terminal device sends the preamble signal to the network device.

Correspondingly, the network device receives the preamble signal, to continue completing a random access process.

In a possible implementation, when the terminal device sends the preamble signal, the RU may alternatively receive the preamble sent by the terminal device, to continue completing the random access process. In other words, a body that receives the preamble may alternatively be a RAN node. For example, the RAN node is the RU. After receiving the preamble signal, the RU completes the random access process.

In another possible implementation, when the terminal device sends the preamble, the RU may alternatively receive the preamble sent by the terminal device, and sends the preamble to the DU after performing processing (for example, noise reduction processing) on the preamble. After receiving the preamble sent by the RU, the DU continues completing the random access process. In other words, a body that finally receives the preamble may alternatively be a RAN node. For example, the RAN node is the DU, and the DU completes the random access process.

For example, the terminal device may send the preamble signal to the network device or the RAN node in the OFDM waveform.

For another example, the terminal device may alternatively send the preamble signal to the network device or the RAN node in the DFT-s-OFDM waveform, so that the PAPR of the preamble signal can be low, thereby improving the transmission efficiency of the preamble.

According to the information transmission method provided in this embodiment of this disclosure, the preamble sequence is obtained by using the product (for example, the Kronecker product) of the K vectors, to increase a quantity of preamble sequences, so as to satisfy a communication requirement of a system. In the random access process, a quantity of users using the preamble sequences for access can be increased. This improves efficiency of random access by using a preamble.

Based on a manner of obtaining the preamble sequence by using the product of the K vectors, a large quantity of preamble sequences can be generated, thereby improving efficiency of communication using the preamble. However, in the random access process, due to uplink asynchronization, a time domain offset (Timing Offset) and a frequency domain offset (Frequency Offset) exist, and random access efficiency and precision are reduced. Therefore, an asynchronization problem in the random access process in which the preamble sequence generated by using the product of the K vectors is used needs to be resolved.

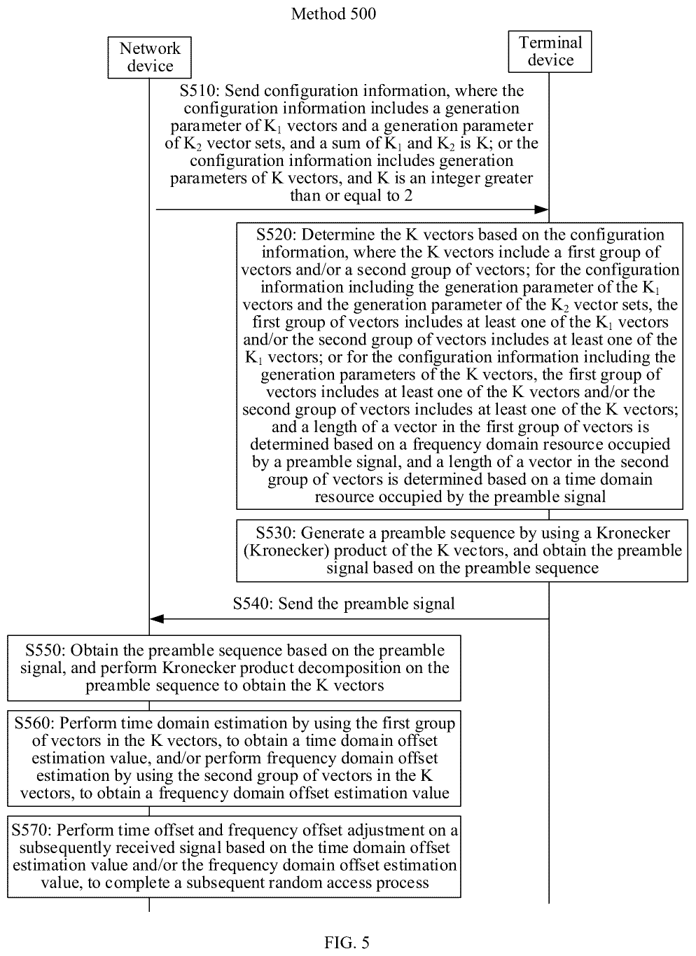

The following describes, with reference to a method shown in FIG. 5, a solution to the asynchronization problem in the random access process. The method 500 shown in FIG. 5 may include S510 to S570. The following describes each step in the method 500 in detail with reference to FIG. 5.

S510: A network device sends configuration information to a terminal device, where the configuration information includes a generation parameter of K₁ vectors and a generation parameter of K₂ vector sets, and a sum of K₁ and K₂ is K; or the configuration information includes generation parameters of K vectors, and K is an integer greater than or equal to 2.

Correspondingly, the terminal device receives the configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

S520: After receiving the configuration information, the terminal device determines the K vectors based on the configuration information. The K vectors include a first group of vectors and/or a second group of vectors. For the configuration information including the generation parameter of the K₁ vectors and the generation parameter of the K₂ vector sets, the first group of vectors includes at least one of the K₁ vectors, and/or the second group of vectors includes at least one of the K₁ vectors. For the configuration information including the generation parameters of the K vectors, the first group of vectors includes at least one of the K vectors, and/or the second group of vectors includes at least one of the K vectors. A length of a vector in the first group of vectors is determined based on a frequency domain resource occupied by a preamble signal, and a length of a vector in the second group of vectors is determined based on a time domain resource occupied by the preamble signal.

For specific processes of S510 and S520, refer to the descriptions corresponding to S410 and S420 in the method 400. For brevity, details are not described herein again.

Optionally, in this embodiment of this disclosure, in a possible implementation, the K vectors may be grouped into one group or two groups. For example, the K vectors include the first group of vectors and/or the second group of vectors.

For the configuration information including the generation parameter of the K₁ vectors and the generation parameter of the K₂ vector sets, the first group of vectors may include at least one of the K₁ vectors, and/or the second group of vectors includes at least one of the K₁ vectors. The K₁ vectors are generated by using the generation parameter of the K₁ vectors. Any one of the K₁ vectors cannot belong to both the first group of vectors and the second group of vectors, that is, the vector included in the first group of vectors is different from the vector included in the second group of vectors. The generation parameter of the K₁ vectors may be determined based on the frequency domain resource or the time domain resource occupied by the preamble signal. Alternatively, a part of the generation parameter of the K₁ vectors may be determined based on the frequency domain resource occupied by the preamble signal, and a part of the generation parameter of the K₁ vectors may be determined based on the time domain resource occupied by the preamble signal.

For the configuration information including the generation parameters of the K vectors, the first group of vectors may include at least one of the K vectors, and/or the second group of vectors includes at least one of the K vectors. The K vectors are generated by using the generation parameters of the K vectors. Any one of the K vectors cannot belong to both the first group of vectors and the second group of vectors, that is, the vector included in the first group of vectors is different from the vector included in the second group of vectors. The generation parameters of the K vectors may be determined based on the frequency domain resource or the time domain resource occupied by the preamble signal. Alternatively, a part of the generation parameters of the K vectors may be determined based on the frequency domain resource occupied by the preamble signal, and a part of the generation parameters of the K vectors may be determined based on the time domain resource occupied by the preamble signal.

The length of the vector in the first group of vectors may be determined based on the frequency domain resource occupied by the preamble signal (or the length of each vector in the first group of vectors is related to the frequency domain resource occupied by the preamble signal), and the length of the vector in the second group of vectors is determined based on the time domain resource occupied by the preamble signal (or the length of each vector in the second group of vectors is related to the time domain resource occupied by the preamble signal).

For example, a relationship between the length of the vector in the first group of vectors and the frequency domain resource occupied by the preamble signal satisfies at least one of the following two conditions:

Condition 1: A product of the lengths of different vectors in the first group of vectors (or the lengths of all the vectors in the first group of vectors) is a quantity of subcarriers occupied by the preamble signal. Condition 2: The quantity of subcarriers occupied by the preamble signal can be exactly divided by the length of each vector in the first group of vectors, or the length of each vector in the first group of vectors is a factor of the quantity of subcarriers occupied by the preamble signal.

It should be understood that, in embodiments of this disclosure, the symbol, also referred to as a time-domain symbol, may be an orthogonal frequency division multiplexing (OFDM) symbol, or may be a single carrier frequency division multiple access (SC-FDMA) symbol. SC-FDMA is also referred to as orthogonal frequency division multiplexing with transform precoding (OFDM with TP). This is not limited herein in this embodiment of this disclosure.

For example, a relationship between the length of the vector in the second group of vectors and the time domain resource occupied by the preamble signal satisfies at least one of the following two conditions:

Condition 1: A product of the lengths of different vectors (or the lengths of all the vectors) in the second group of vectors is a quantity of time-domain symbols occupied by the preamble signal. Condition 2: The length of each vector in the second group of vectors is a factor of the quantity of time-domain symbols occupied by the preamble signal. In other words, the quantity of symbols occupied by the preamble signal can be exactly divided by the length of each vector in the second group of vectors.

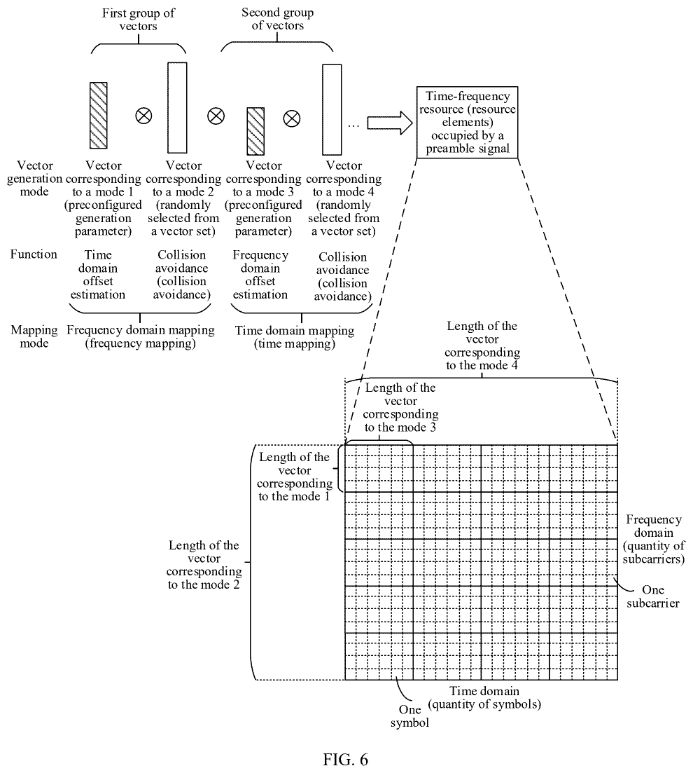

For example, it is assumed that the network device configures generation parameters of two vectors (vectors respectively corresponding to a mode 1 and a mode 3), that is, K₁ is equal to 2, and configures generation parameters of two vector sets, that is, K₂ is also equal to 2. In this case, the first group of vectors may include vectors respectively corresponding to the mode 1 and a mode 2, and lengths of the vectors respectively corresponding to the mode 1 and the mode 2 may be determined based on the frequency domain resource occupied by the preamble signal (in other words, the length of each vector in the first group of vectors is related to the frequency domain resource occupied by the preamble signal). The second group of vectors may include vectors respectively corresponding to the mode 3 and a mode 4, and lengths of the vectors respectively corresponding to the mode 3 and the mode 4 may be determined based on the time domain resource occupied by the preamble signal (in other words, the length of each vector in the second group of vectors is related to the time domain resource occupied by the preamble signal). For example, FIG. 6 is a diagram of an example in which the terminal device generates a preamble sequence by using the vectors corresponding to the mode 1 to the mode 4.

In the example shown in FIG. 6, a resource mapping manner of the preamble signal is frequency-domain mapping (Frequency Mapping) first and then time-domain mapping (Time Mapping). The frequency domain resource (for example, a quantity of occupied subcarriers is used for description) occupied by the preamble signal is 20 occupied subcarriers, the length of the vector corresponding to the mode 1 is 4, the length of the vector corresponding to the mode 2 is 5, the lengths of the vectors respectively corresponding to the mode 1 and the mode 2 are both factors of the 20 subcarriers occupied by the preamble signal, and a product (4×5=20) of the lengths of the vectors respectively corresponding to the mode 1 and the mode 2 is the quantity of subcarriers occupied by the preamble signal, namely, 20. In the example shown in FIG. 6, the vector corresponding to the mode 1 is generated based on a configured generation parameter of the vector corresponding to the mode 1, the vector corresponding to the mode 3 is generated based on a configured generation parameter of the vector corresponding to the mode 3, the vector corresponding to the mode 2 is randomly selected from a vector set (referred to as a vector set 1 for differentiation), and a vector corresponding to the mode 4 is randomly selected from another vector set (referred to as a vector set 2 for differentiation). In this case, for different terminal devices, a probability of selecting a same vector from the vector set 1 is low, and a probability of selecting a same vector from the vector set 2 is also low. Therefore, a probability that different terminal devices select a same vector corresponding to the mode 2 and a same vector corresponding to the mode 4 is low. In this way, a probability that different terminal devices select a same vector to generate a preamble sequence is reduced, thereby reducing a probability of interference or a collision between preamble sequences of different terminal devices, and improving quality and efficiency of communication.

In the example shown in FIG. 6, the time domain resource (a quantity of occupied symbols is used as an example for description) occupied by the preamble signal is 24 occupied symbols, the length of the vector corresponding to the mode 3 is 6, the length of the vector corresponding to the mode 4 is 4, and the lengths of the vectors respectively corresponding to the mode 3 and the mode 4 are both factors of the 24 symbols occupied by the preamble signal. In addition, a product (6×4=24) of the lengths of the vectors respectively corresponding to the mode 3 and the mode 4 is the quantity of symbols occupied by the preamble signal, namely, 24.

It should be understood that, in embodiments of this disclosure, the length of the vector in the first group of vectors and the frequency domain resource occupied by the preamble signal may alternatively satisfy another relationship, and the length of the vector in the second group of vectors and the time domain resource occupied by the preamble signal may alternatively satisfy another relationship. The foregoing conditions are merely examples, and should not constitute any limitation on embodiments of this disclosure.

S530: The terminal device generates a preamble sequence by using a Kronecker product of the K vectors, and obtains a preamble signal based on the preamble sequence.

S540: The terminal device sends the preamble signal to the network device.

In a possible implementation, when the terminal device sends the preamble, the RU may alternatively receive the preamble sent by the terminal device, to continue completing the random access process. In other words, a body that receives the preamble may alternatively be a RAN node. For example, the RAN node is the RU. After receiving the preamble signal, the RU completes the random access process.

In another possible implementation, when the terminal device sends the preamble, the RU may alternatively receive the preamble sent by the terminal device, and sends the preamble to the DU after performing processing (for example, noise reduction processing) on the preamble. After receiving the preamble sent by the RU, the DU continues completing the random access process. In other words, a body that finally receives the preamble may alternatively be a RAN node. For example, the RAN node is the DU.

For example, the terminal device may send the preamble signal to the network device or the RAN node in an OFDM waveform.

For another example, the terminal device may alternatively send the preamble signal to the network device or the RAN node in a DFT-s-OFDM waveform, so that a PAPR of the preamble signal can be low, thereby improving transmission efficiency of the preamble.

Correspondingly, the network device receives the preamble signal, to continue completing the random access process.

For descriptions of S530 and S540, refer to the foregoing descriptions of S430 and S440. For brevity, details are not described herein again.

S550: The network device obtains the preamble sequence based on the preamble signal, and performs Kronecker product decomposition on the preamble sequence to obtain the K vectors.

In a possible implementation, the RU may obtain the preamble sequence based on the preamble signal, and perform the Kronecker product decomposition on the preamble sequence to obtain the K vectors. In other words, an execution body of S550 may be the RAN node. For example, the RAN node is the RU.

In another possible implementation, the DU may alternatively obtain the preamble sequence based on the preamble signal, and perform the Kronecker product decomposition on the preamble sequence to obtain the K vectors. In other words, an execution body of S550 may also be the RAN node. For example, the RAN node is the DU.

For example, with reference to the example shown in FIG. 6, the network device configures generation parameters of two vectors (the vectors respectively corresponding to the mode 1 and the mode 3), that is, K₁ is equal to 2, and configures generation parameters of two vector sets. The first group of vectors includes the vectors corresponding to the mode 1 and the mode 2, and the second group of vectors includes the vectors respectively corresponding to the mode 3 and the mode 4. The lengths of the vectors respectively corresponding to the mode 1 and the mode 2 may be determined based on the frequency domain resource occupied by the preamble signal (in other words, the length of each vector in the first group of vectors is related to the frequency domain resource occupied by the preamble signal). The lengths of the vectors respectively corresponding to the mode 3 and the mode 4 may be determined based on the time domain resource occupied by the preamble signal (in other words, the length of each vector in the second group of vectors is related to the time domain resource occupied by the preamble signal). The network device obtains the preamble sequence based on the preamble signal, and performs the Kronecker product decomposition on the preamble sequence to obtain the vectors respectively corresponding to the mode 1 to the mode 4.

S560: The network device performs time domain estimation by using the first group of vectors in the K vectors, to obtain a time domain offset estimation value, and/or performs frequency domain offset estimation by using the second group of vectors in the K vectors, to obtain a frequency domain offset estimation value.

In a possible implementation, the RU may alternatively perform the time domain estimation by using the first group of vectors in the K vectors, to obtain the time domain offset estimation value, and/or perform the frequency domain offset estimation by using the second group of vectors in the K vectors, to obtain the frequency domain offset estimation value. In other words, an execution body of S560 may be the RAN node. For example, the RAN node is the RU.

In a possible implementation, the DU may alternatively perform the time domain estimation by using the first group of vectors in the K vectors, to obtain the time domain offset estimation value, and/or perform the frequency domain offset estimation by using the second group of vectors in the K vectors, to obtain the frequency domain offset estimation value. In other words, an execution body of S560 may be the RAN node. For example, the RAN node is the DU.

For example, with reference to the example shown in FIG. 6, the network device may perform time domain offset estimation by using the vector corresponding to the mode 1, to obtain a time domain offset estimation value. The network device performs frequency domain offset estimation by using the vector corresponding to the mode 3, to obtain a frequency domain offset estimation value.

Certainly, in another implementation of this disclosure, if K₁ is equal to 1, that is, the network device configures a generation parameter of only one vector (regardless of how many generation parameters of vector sets are configured), it is assumed that a vector A is generated by using the generation parameter of the vector. In this case, in a possible implementation, the first group of vectors includes the vector A, and a length of the vector A is determined based on the frequency domain resource occupied by the preamble signal. In other words, the generation parameter of the vector A is determined based on the frequency domain resource occupied by the preamble signal. For example, the length of the vector A is a factor of the quantity of subcarriers occupied by the preamble signal, and/or a product of the length of the vector A and a length of another vector in the first group of vectors is the quantity of subcarriers occupied by the preamble signal. In this case, there is no second group of vectors. The terminal device obtains the preamble signal by using the product of the K vectors (the K vectors include the vector A), and sends the preamble signal to the network device. After obtaining the K vectors based on the preamble signal, the network device may perform time domain offset estimation by using the vector A in the first group of vectors, to obtain a time domain offset estimation value. The network device performs no frequency domain offset estimation. In another possible implementation, a length of the vector A is determined based on the time domain resource occupied by the preamble signal, or the generation parameter of the vector A is determined based on the time domain resource occupied by the preamble signal. For example, the length of the vector A is a factor of the quantity of symbols occupied by the preamble signal, and/or a product of the length of the vector A and a length of another vector in the second group of vectors is the quantity of symbols occupied by the preamble signal. The second group of vectors includes the vector A. In this case, there is no first group of vectors. The terminal device obtains the preamble signal by using the product of the K vectors (the K vectors include the vector A), and sends the preamble signal to the network device. After obtaining the K vectors based on the preamble signal, the network device may perform frequency domain offset estimation by using the vector A in the second group of vectors, to obtain a frequency domain offset estimation value. The network device performs no time domain offset estimation.

Certainly, in another embodiment of this disclosure, it is assumed that K₁ is greater than 1, that is, the network device configures generation parameters of a plurality of vectors (regardless of how many generation parameters of vector sets are configured (a value of K₁ is less than K), or no generation parameter of a vector set is configured (a value of K₁ may be equal to K)). In this case:

In a possible implementation, lengths of the K₁ vectors generated by using the generation parameters of the K₁ vectors are all determined based on the frequency domain resource occupied by the preamble signal, or the generation parameters of the K₁ vectors are all determined based on the frequency domain resource occupied by the preamble signal. For example, the length of each vector in the K₁ vectors is a factor of the quantity of subcarriers occupied by the preamble signal, and/or a product of the length of any vector in the K₁ vector and a length of another vector in the first group of vectors is the quantity of subcarriers occupied by the preamble signal. In this case, the first group of vectors may include the K₁ vectors, and there is no second group of vectors. The terminal device obtains the preamble signal by using the product of the K vectors (the K vectors include the K₁ vectors), and sends the preamble signal to the network device. After obtaining the K vectors based on the preamble signal, the network device may perform time domain offset estimation by using the K₁ vectors in the first group of vectors, to obtain a time domain offset estimation value. The network device performs no frequency domain offset estimation.

In another possible implementation, lengths of the K₁ vectors are all determined based on the time domain resource occupied by the preamble signal, or the generation parameters of the K₁ vectors are all determined based on the time domain resource occupied by the preamble signal. For example, the length of each vector in the K₁ vectors is a factor of the quantity of time-domain symbols occupied by the preamble signal, and/or a product of a length of any vector in the K₁ vectors and a length of another vector in the second group of vectors is the quantity of time-domain symbols occupied by the preamble signal. In this case, the second group of vectors includes the K₁ vectors, and there is no first group of vectors. The terminal device obtains the preamble signal by using the product of the K vectors (the K vectors include the K₁ vectors), and sends the preamble signal to the network device. After obtaining the K vectors based on the preamble signal, the network device performs frequency domain offset estimation by using the K₁ vectors, to obtain a frequency domain offset estimation value. The network device performs no time domain offset estimation.

For example, the network device configures generation parameters of four vectors. In a possible implementation, lengths of the four vectors generated based on the generation parameters of the four vectors are all determined based on the frequency domain resource occupied by the preamble signal. For example, the lengths of the four vectors are all factors of the quantity of subcarriers occupied by the preamble signal. That is, the first group of vectors may include the four vectors. The terminal device obtains the preamble signal by using the product of the K vectors (including the four vectors), and sends the preamble signal to the network device. After obtaining the K (a value of K may be equal to or greater than 4) vectors based on the preamble signal, the network device may perform time domain offset estimation by using the four vectors in the first group of vectors, to obtain a time domain offset estimation value. In another possible implementation, lengths of the four vectors generated based on the generation parameters of the four vectors are all determined based on the time domain resource occupied by the preamble signal. For example, the lengths of the four vectors are all factors of the quantity of symbols occupied by the preamble signal. That is, the second group of vectors may include the four vectors. After obtaining the K (a value of K may be equal to or greater than 4) vectors, the network device may perform frequency domain offset estimation by using the four vectors in the second group of vectors, to obtain a frequency domain offset estimation value.

Certainly, in another embodiment of this disclosure, if K₁ is greater than 1, that is, the network device configures generation parameters of a plurality of vectors (regardless of how many generation parameters of vector sets are configured (a value of K₁ is greater than 1 ans is less than or equal to K), or no generation parameter of a vector set is configured (a value of K₁ may be equal to K)), lengths of a part of the K₁ vectors (referred to as a first part of the vectors for differentiation) are all determined based on the frequency domain resource occupied by the preamble signal, and lengths of another part of the K₁ vectors (referred to as a second part of the vectors for differentiation) are all determined based on the time domain resource occupied by the preamble signal. In this case, the first group of vectors may include the first part of the K₁ vectors. The second group of vectors includes the second part of the K₁ vectors. The terminal device obtains the preamble signal by using the product of the K vectors (the K vectors include the K₁ vectors), and sends the preamble signal to the network device. After obtaining the K vectors based on the preamble signal, the network device may perform time domain offset estimation by using the first part of the first group of vectors, to obtain a time domain offset estimation value. The network device may perform time domain offset estimation by using the second part of the second group of vectors, to obtain a frequency domain offset estimation value.

For example, in the example shown in FIG. 6, a length of a part (the vector corresponding to the mode 1) of the K₁ (two) vectors is determined based on the frequency domain resource occupied by the preamble signal, and a length of another part (the vector corresponding to the mode 3) of the K₁ vectors is determined based on the time domain resource occupied by the preamble signal.

S570: The network device performs time offset and frequency offset adjustment on a subsequently received signal based on the time domain offset estimation value and/or the frequency domain offset estimation value, to complete a subsequent random access process.

In a possible implementation, the RU may alternatively perform the time offset and frequency offset adjustment on the subsequently received signal based on the time domain offset estimation value and/or the frequency domain offset estimation value, to complete the subsequent random access process. In other words, an execution body of S570 may also be the RAN node. For example, the RAN node is the RU.

In another possible implementation, the DU may alternatively perform the time offset and frequency offset adjustment on the subsequently received signal based on the time domain offset estimation value and/or the frequency domain offset estimation value, to complete the subsequent random access process. In other words, an execution body of S570 may also be the RAN node. For example, the RAN node is the DU.

For example, the network device may perform, based on the time domain offset estimation value and/or the frequency domain offset estimation value, time domain and/or frequency domain adjustment on the signal subsequently received in the random access process. This ensures random access efficiency and precision, to resolve an asynchronization problem in the random access process in which the preamble sequence generated by using the Kronecker product of the K vectors is used.

According to the information transmission method provided in this embodiment of this disclosure, a large quantity of preamble sequences may be generated based on a manner of obtaining the preamble sequence by using the product of the K vectors, to satisfy a communication requirement of a system. In the random access process, a quantity of users using the preamble sequences for access can be increased. This improves efficiency of random access by using a preamble. In addition, in a vector corresponding to a generation parameter that is preconfigured by the network device and that is of the vector, a length of the vector is determined based on a frequency domain resource occupied by a preamble signal, and/or the length of the vector is determined based on a time domain resource occupied by the preamble signal. Time domain offset estimation and/or frequency domain offset estimation are/is performed by using the vector corresponding to the generation parameter that is preconfigured by the network device and that is of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

Optionally, in another implementation of this disclosure, S550 to S570 may be all performed by the RU, or may be all performed by the DU, or may be performed by the RU and the DU through collaboration.

When the RU collaborates with the DU, for example, after receiving the preamble signal, the RU may perform S550 to send the obtained K vectors to the DU, and then the DU performs S560 and S570. For another example, after receiving the preamble signal, the RU may perform S550 and S560 to send the obtained time domain offset estimation value and/or frequency domain offset estimation value to the DU, and then the DU performs S570.

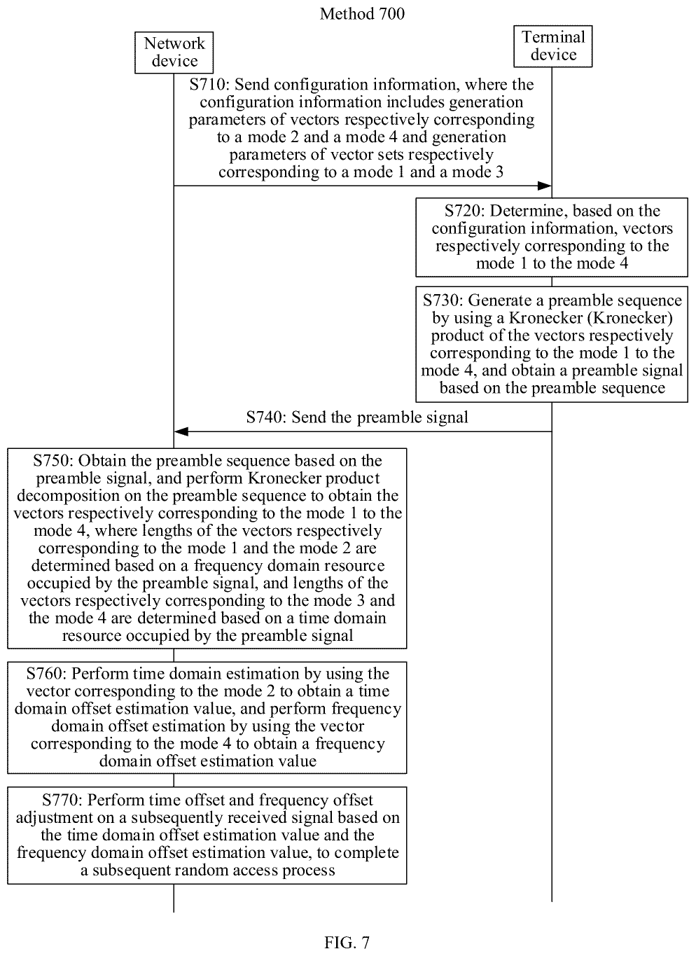

FIG. 7 is a schematic interaction diagram of an information transmission method according to another embodiment of this disclosure. As shown in FIG. 7, the method 700 shown in FIG. 7 may include S710 to S770. The following describes each step in the method 700 in detail with reference to FIG. 7.

S710: A network device sends configuration information to a terminal device, where the configuration information includes generation parameters of vectors respectively corresponding to a mode 2 and a mode 4 and generation parameters of vector sets respectively corresponding to a mode 1 and a mode 3.

In other words, the configuration information includes the generation parameters of the two vectors and the generation parameters of the two vector sets. A vector corresponding to the mode 1, the vector corresponding to the mode 2, a vector corresponding to the mode 3, and the vector corresponding to the mode 4 are vectors respectively corresponding to four modes or dimensions (modes) of a tensor.

Optionally, in a possible implementation, the generation parameters of the two vectors and the generation parameters of the two vector sets are determined based on (or related to) a cell ID of the terminal device.

It should be understood that, in embodiments of this disclosure, the generation parameters of the two vectors and the generation parameters of the two vector sets may alternatively be sent to the terminal device separately through different signaling or indication information. In other words, the generation parameter of the two vectors may be sent to the terminal device through one piece of configuration information, and the generation parameter of the two vectors may be sent to the terminal device through another piece of configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

S720: After receiving the configuration information, the terminal device determines, based on the configuration information, the vectors respectively corresponding to the mode 1 to the mode 4.

For specific processes of S710 and S720, refer to the descriptions corresponding to the method 400 or the method 500. For brevity, details are not described herein again.

Optionally, in a possible implementation, after the terminal device obtains the two vector sets (the vector sets respectively corresponding to the mode 1 and the mode 3), for any vector set, the terminal device may further perform a cyclic shift on one or more elements (one element is one vector) in the vector set to obtain a new vector. In this way, a quantity of vectors included in the vector set can be increased. Then, the terminal device selects one vector from each vector set, to obtain the two vectors (the vectors respectively corresponding to the mode 1 and the mode 3). In this way, a range in which the terminal device selects vectors from vector sets can be increased, thereby reducing a probability of interference or a collision between different terminal devices, and improving quality and efficiency of communication.

Optionally, in a possible implementation, lengths of the vectors respectively corresponding to the mode 1 and the mode 2 are determined based on a frequency domain resource occupied by a preamble signal. Lengths of the vectors respectively corresponding to the mode 3 and the mode 4 may be determined based on a time domain resource occupied by the preamble signal. In other words, the generation parameters of the vectors respectively corresponding to the mode 1 and the mode 2 may be determined based on the frequency domain resource occupied by the preamble signal. The generation parameters of the vectors respectively corresponding to the mode 3 and the mode 4 may be determined based on the time domain resource occupied by the preamble signal.

S730: The terminal device generates a preamble sequence by using a Kronecker product of the vectors respectively corresponding to the mode 1 to the mode 4, and obtains the preamble signal based on the preamble sequence.

For example, the terminal device performs Kronecker multiplication on the four vectors, that is, performs an operation of mode 4*mode 3*mode 2*mode 1, where “*” represents the Kronecker multiplication, and “mode i” represents a vector corresponding to the mode, to obtain the preamble sequence.

Optionally, the terminal device may further perform a cyclic shift on the generated preamble sequence to obtain a cyclically shifted preamble sequence, and add a cyclic prefix to the cyclically shifted preamble sequence to obtain a preamble signal, so that a quantity of available preamble sequences can be further increased. Optionally, a value of the cyclic shift may be indicated by the network device to the terminal device, or may be predefined in a protocol.

In a possible implementation, the generation parameters of the two vectors and/or the generation parameters of the two vector sets are determined based on (or related to) the cell ID of the terminal device. Different cells correspond to different cell IDs. Therefore, four vectors selected or determined by each of terminal devices in different cells are not completely the same. Further, preamble sequences generated by using Kronecker products of the four vectors are also different. This can reduce interference between the cells and improve quality and efficiency of communication.

S740: The terminal device sends the preamble signal to the network device.

Correspondingly, the network device receives the preamble signal, to continue completing a random access process.

In a possible implementation, when the terminal device sends the preamble, the RU may alternatively receive the preamble sent by the terminal device, to continue completing the random access process. In other words, a body that receives the preamble may alternatively be the RAN node. For example, the RAN node is the RU. After receiving the preamble signal, the RU continues completing the random access process.

In another possible implementation, when the terminal device sends the preamble, the RU may alternatively receive the preamble sent by the terminal device, and sends the preamble to the DU after performing processing (for example, noise reduction processing) on the preamble. After receiving the preamble sent by the RU, the DU continues completing the random access process. In other words, a body that finally receives the preamble may alternatively be the RAN node. For example, the RAN node is the DU.

For example, the terminal device may send the preamble signal to the network device or the RAN node in an OFDM waveform.

For another example, the terminal device may alternatively send the preamble signal to the network device or the RAN node in a DFT-s-OFDM waveform, so that a PAPR of the preamble signal can be low, thereby improving transmission efficiency of the preamble.

According to the method 700, the preamble sequence is obtained by using the Kronecker product of the four vectors. This increases a quantity of preamble sequences, to satisfy a communication requirement of a system and improve communication efficiency. For example, a quantity of users using preamble sequences for access can be increased.

Optionally, in a possible implementation, in the method 700, the lengths of the vectors respectively corresponding to the mode 1 and the mode 2 may be determined based on the frequency domain resource occupied by the preamble signal. The lengths of the vectors respectively corresponding to the mode 3 and the mode 4 may be determined based on the time domain resource occupied by the preamble signal. In other words, the four vectors may be grouped into two groups. A first group of vectors includes the vectors respectively corresponding to the mode 1 and the mode 2, and a second group of vectors includes the vectors respectively corresponding to the mode 3 and the mode 4. The length of the vector in the first group of vectors may be determined based on the frequency domain resource occupied by the preamble signal (or the length of each vector in the first group of vectors is related to the frequency domain resource occupied by the preamble signal), and the length of the vector in the second group of vectors is determined based on the time domain resource occupied by the preamble signal (or the length of each vector in the second group of vectors is related to the time domain resource occupied by the preamble signal).

For example, the lengths of the vectors respectively corresponding to the mode 1 and the mode 2 are both factors of a quantity of subcarriers occupied by the preamble signal, and/or a product of the lengths of the vectors respectively corresponding to the mode 1 and the mode 2 is the quantity of subcarriers occupied by the preamble signal. The lengths of the vectors respectively corresponding to the mode 3 and the mode 4 are both factors of a quantity of symbols occupied by the preamble signal, and/or a product of the lengths of the vectors respectively corresponding to the mode 3 and the mode 4 is the quantity of symbols occupied by the preamble signal.

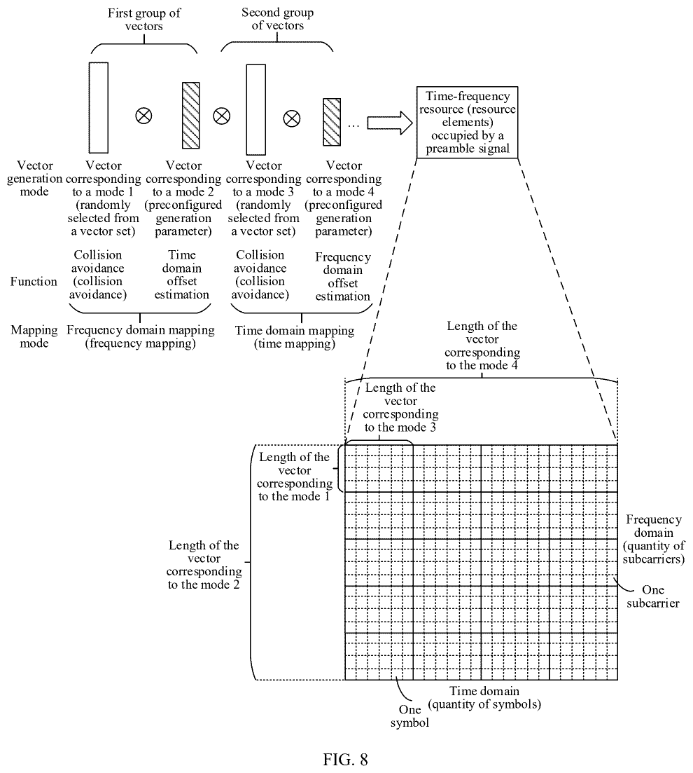

For example, FIG. 8 is a diagram of an example in which the terminal device generates a preamble sequence by using vectors corresponding to a mode 1 to a mode 4.

In the example shown in FIG. 8, a resource mapping manner of a preamble signal is frequency-domain mapping (Frequency Mapping) first and then time-domain mapping (Time Mapping). A frequency domain resource (for example, a quantity of occupied subcarriers is used for description) occupied by the preamble signal is 20 occupied subcarriers, a length of the vector corresponding to the mode 1 is 4, a length of the vector corresponding to the mode 2 is 5, the lengths of the vectors respectively corresponding to the mode 1 and the mode 2 are both factors of the 20 subcarriers occupied by the preamble signal, and a product (4×5=20) of the lengths of the vectors respectively corresponding to the mode 1 and the mode 2 is the quantity of subcarriers occupied by the preamble signal, namely, 20.

In the example shown in FIG. 8, the vector corresponding to the mode 1 is randomly selected from a vector set (referred to as a vector set 1 for differentiation), and a vector corresponding to the mode 3 is randomly selected from another vector set (referred to as a vector set 2 for differentiation). In this case, for different terminal devices, a probability of selecting a same vector from the vector set 1 is low, and a probability of selecting a same vector from the vector set 2 is also low. Therefore, a probability that different terminal devices select a same vector corresponding to the mode 1 and a same vector corresponding to the mode 3 is low. In this way, a probability that different terminal devices select a same vector to generate a preamble sequence is reduced, thereby reducing a probability of interference or a collision between preamble sequences of different terminal devices, and improving quality and efficiency of communication.

In the example shown in FIG. 8, a time domain resource (a quantity of occupied symbols is used as an example for description) occupied by the preamble signal is 24 occupied symbols, a length of the vector corresponding to the mode 3 is 6, a length of the vector corresponding to the mode 4 is 4, and the lengths of the vectors respectively corresponding to the mode 3 and the mode 4 are both factors of the 24 symbols occupied by the preamble signal. In addition, a product (6×4=24) of the lengths of the vectors respectively corresponding to the mode 3 and the mode 4 is the quantity of symbols occupied by the preamble signal, namely, 24.

Optionally, after receiving the preamble signal, the network device may further perform S750 to S770.

S750: The network device obtains the preamble sequence based on the preamble signal, and performs the Kronecker product decomposition on the preamble sequence to obtain the vectors respectively corresponding to the mode 1 to the mode 4. The lengths of the vectors respectively corresponding to the mode 1 and the mode 2 are determined based on the frequency domain resource occupied by the preamble signal. The lengths of the vectors respectively corresponding to the mode 3 and the mode 4 may be determined based on the time domain resource occupied by the preamble signal.

S760: The network device performs time domain estimation by using the vector corresponding to the mode 2 to obtain a time domain offset estimation value, and performs frequency domain offset estimation by using the vector corresponding to the mode 4 to obtain a frequency domain offset estimation value.

For example, with reference to the foregoing example, the network device may perform time domain offset estimation by using the vector corresponding to the mode 2, to obtain the time domain offset estimation value. The network device performs the frequency domain offset estimation by using the vector corresponding to the mode 4, to obtain the frequency domain offset estimation value.

S770: The network device performs time offset and frequency offset adjustment on a subsequently received signal based on the time domain offset estimation value and the frequency domain offset estimation value, to complete a subsequent random access process.

For example, the network device may perform, based on the time domain offset estimation value and the frequency domain offset estimation value, time domain and frequency domain adjustment on the signal subsequently received in the random access process. This ensures random access efficiency and precision, to resolve an asynchronization problem in the random access process in which the preamble sequence generated by using the Kronecker product of the K vectors is used.

According to the information transmission method provided in this embodiment of this disclosure, based on a manner of obtaining the preamble sequence by using the product of the K (for example, four) vectors, a large quantity of preamble sequences can be generated, thereby improving efficiency of performing random access by using the preamble. In addition, in a vector corresponding to a generation parameter that is preconfigured by the network device and that is of the vector, a length of a part of the vector is determined based on a frequency domain resource occupied by a preamble signal, and a length of a part of the vector is determined based on a time domain resource occupied by the preamble signal. Time domain offset estimation and frequency domain offset estimation are performed by using the vector corresponding to the generation parameter that is preconfigured by the network device and that is of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

Certainly, for the network device that configures a generation parameter of the vector corresponding to the mode 2 and a generation parameter of the vector corresponding to the mode 4, according to the preamble sequence generation manner shown in FIG. 8, the network device performs time domain offset estimation by using the vector corresponding to the mode 2 to obtain a time domain offset estimation value, and performs frequency domain offset estimation by using the vector corresponding to the mode 4 to obtain a frequency domain offset estimation value. Estimation precision of the time domain offset estimation and the frequency domain offset estimation is high.

For the network device that configures a generation parameter of the vector corresponding to the mode 1 and a generation parameter of the vector corresponding to the mode 3, according to the preamble sequence generation manner shown in FIG. 6, the network device performs time domain offset estimation by using the vector corresponding to the mode 1 to obtain a time domain offset estimation value, and performs frequency domain offset estimation by using the vector corresponding to the mode 3 to obtain a frequency domain offset estimation value. An estimation range of the time domain offset estimation and the frequency domain offset estimation is large.

Optionally, in another implementation of this disclosure, S750 to S770 may be all performed by the RU, or may be all performed by the DU, or may be performed by the RU and the DU through collaboration.

When the RU collaborates with the DU, for example, after receiving the preamble signal, the RU may perform S750 to send the obtained vectors respectively corresponding to the mode 1 to the mode 4 to the DU, and then the DU performs S760 and S770. For another example, after receiving the preamble signal, the RU may perform S750 and S760 to send the obtained time domain offset estimation value and frequency domain offset estimation value to the DU, and then the DU performs S770.

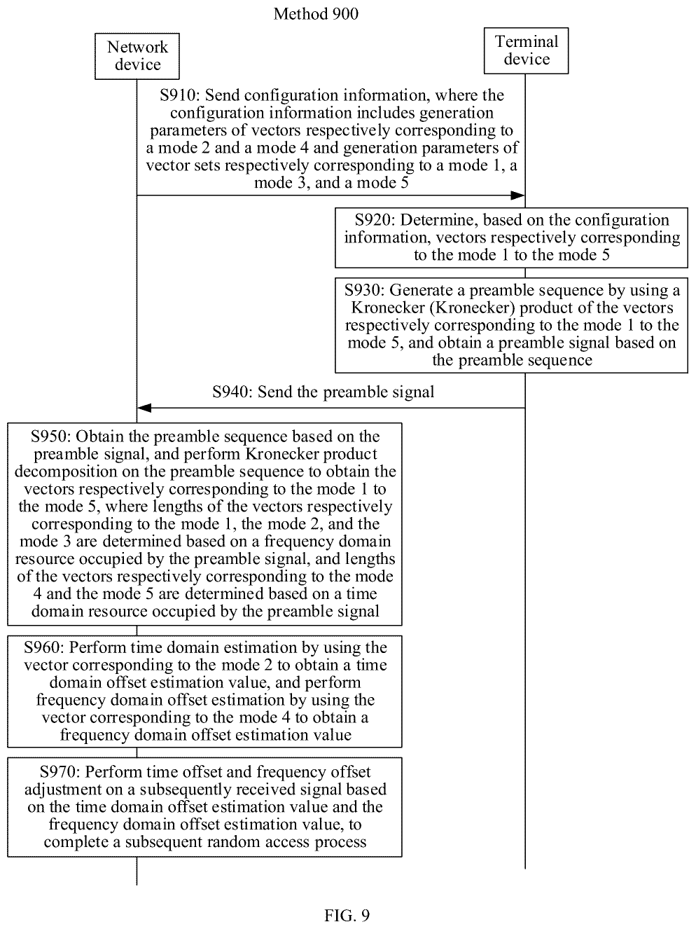

FIG. 9 is a schematic interaction diagram of an information transmission method according to another embodiment of this disclosure. As shown in FIG. 9, the method 900 shown in FIG. 9 may include S910 to S970. The following describes each step in the method 900 in detail with reference to FIG. 9.

S910: A network device sends configuration information to a terminal device, where the configuration information includes generation parameters of vectors respectively corresponding to a mode 2 and a mode 4 and generation parameters of vector sets respectively corresponding to a mode 1, a mode 3, and a mode 5.

In other words, the configuration information includes the generation parameters of the two vectors and the generation parameters of the three vector sets. A vector corresponding to the mode 1, the vector corresponding to the mode 2, a vector corresponding to the mode 3, the vector corresponding to the mode 4, and a vector corresponding to the mode 5 are vectors respectively corresponding to five modes or dimensions (modes) of a tensor.

Correspondingly, the terminal device receives the configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

Optionally, in a possible implementation, the generation parameters of the two vectors and the generation parameters of the three vector sets are determined based on (or related to) a cell ID of the terminal device.

S920: After receiving the configuration information, the terminal device determines, based on the configuration information, the vectors respectively corresponding to the mode 1 to the mode 5.

For specific processes of S910 and S920, refer to the descriptions corresponding to the method 500 or the method 400. For brevity, details are not described herein again.

Optionally, in a possible implementation, lengths of the vectors respectively corresponding to the mode 1, the mode 2, and the mode 3 are determined based on a frequency domain resource occupied by a preamble signal. Lengths of the vectors respectively corresponding to the mode 4 and the mode 5 may be determined based on a time domain resource occupied by the preamble signal. In other words, generation parameters of the vectors respectively corresponding to the mode 1, the mode 2, and the mode 3 may be determined based on the frequency domain resource occupied by the preamble signal. Generation parameters of the vectors respectively corresponding to the mode 4 and the mode 5 may be determined based on the frequency domain resource occupied by the preamble signal.

S930: The terminal device generates a preamble sequence by using a Kronecker product of the vectors respectively corresponding to the mode 1 to the mode 5, and obtains a preamble signal based on the preamble sequence.

For example, the terminal device performs Kronecker multiplication on the five vectors, that is, performs an operation of mode 5*mode 4*mode 3*mode 2*mode 1, where “*” represents the Kronecker multiplication, and “mode i” represents a vector corresponding to the mode, to obtain the preamble sequence.

In a possible implementation, the generation parameters of the two vectors and/or the generation parameters of the three vector sets are determined based on (or related to) the cell ID of the terminal device. Different cells correspond to different cell IDs. Therefore, for terminal devices in different cells, five selected or determined vectors are not completely the same. Further, preamble sequences generated by using Kronecker products of the five vectors are also different. This can reduce interference between the cells and improve quality and efficiency of communication.

Optionally, the terminal device may further perform a cyclic shift on the generated preamble sequence to obtain a cyclically shifted preamble sequence, and add a cyclic prefix to the cyclically shifted preamble sequence to obtain a preamble signal, so that a quantity of available preamble sequences can be further increased. Optionally, a value of the cyclic shift may be indicated by the network device to the terminal device, or may be predefined in a protocol.

S940: The terminal device sends the preamble signal to the network device.

Correspondingly, the network device receives the preamble signal, to continue completing a random access process.

In a possible implementation, when the terminal device sends the preamble, the RU may alternatively receive the preamble sent by the terminal device, to continue completing the random access process. In other words, a body that receives the preamble may alternatively be the RAN node. For example, the RAN node is the RU. After receiving the preamble signal, the RU continues completing the random access process.

In another possible implementation, when the terminal device sends the preamble, the RU may alternatively receive the preamble sent by the terminal device, and sends the preamble to the DU after performing processing (for example, noise reduction processing) on the preamble. After receiving the preamble sent by the RU, the DU continues completing the random access process. In other words, a body that finally receives the preamble may alternatively be the RAN node. For example, the RAN node is the DU.

For example, the terminal device may send the preamble signal to the network device or the RAN node in an OFDM waveform.

For another example, the terminal device may alternatively send the preamble signal to the network device or the RAN node in a DFT-s-OFDM waveform, so that a PAPR of the preamble signal can be low, thereby improving transmission efficiency of the preamble.

According to the method 900, the preamble sequence is obtained by using the Kronecker product of the five vectors. This increases a quantity of preamble sequences, to satisfy a communication requirement of a system and improve communication efficiency. For example, a quantity of users using preamble sequences for access can be increased.

Optionally, in a possible implementation, in the method 900, the lengths of the vectors respectively corresponding to the mode 1, the mode 2, and the mode 3 may be determined based on the frequency domain resource occupied by the preamble signal. The lengths of the vectors respectively corresponding to the mode 4 and the mode 5 may be determined based on the time domain resource occupied by the preamble signal. In other words, the five vectors may be grouped into two groups. A first group of vectors includes the vectors respectively corresponding to the mode 1, the mode 2, and the mode 3, and a second group of vectors includes the vectors respectively corresponding to the mode 4 and the mode 5. The length of the vector in the first group of vectors may be determined based on the frequency domain resource occupied by the preamble signal (or the length of each vector in the first group of vectors is related to the frequency domain resource occupied by the preamble signal), and the length of the vector in the second group of vectors is determined based on the time domain resource occupied by the preamble signal (or the length of each vector in the second group of vectors is related to the time domain resource occupied by the preamble signal).

For example, the lengths of the vectors respectively corresponding to the mode 1, the mode 2, and the mode 3 are all factors of a quantity of subcarriers occupied by the preamble signal, and/or a product of the lengths of the vectors respectively corresponding to the mode 1, the mode 2, and the mode 3 is the quantity of subcarriers occupied by the preamble signal. The lengths of the vectors respectively corresponding to the mode 4 and the mode 5 are both factors of a quantity of symbols occupied by the preamble signal, and/or a product of the lengths of the vectors respectively corresponding to the mode 4 and the mode 5 is a quantity of symbols occupied by the preamble signal.

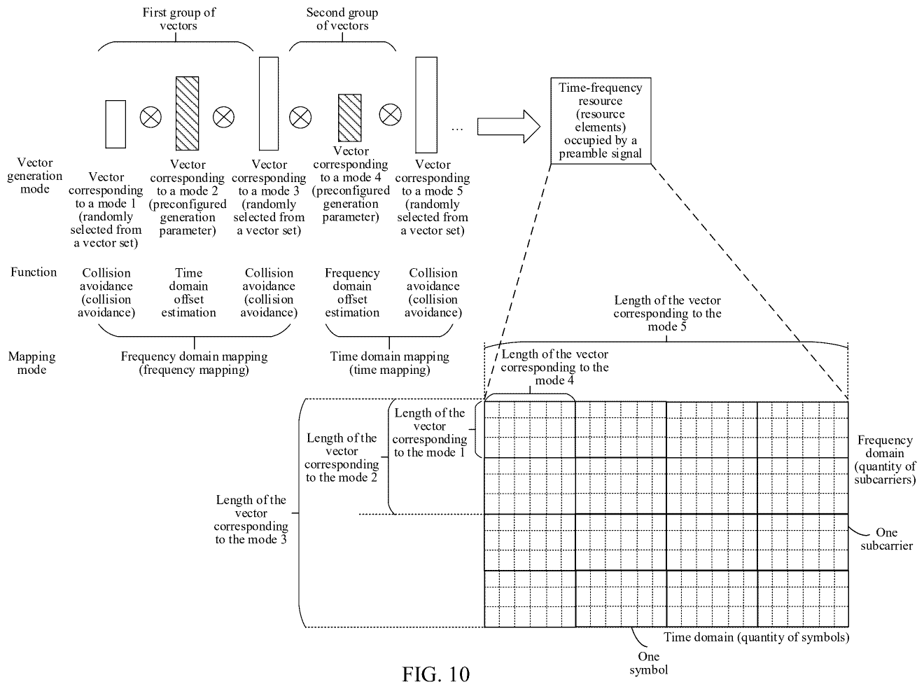

For example, FIG. 10 is a diagram of an example in which the terminal device generates a preamble sequence by using vectors corresponding to a mode 1 to a mode 5.

In the example shown in FIG. 10, a resource mapping manner of a preamble signal is frequency-domain mapping (Frequency Mapping) first and then time-domain mapping (Time Mapping). A frequency domain resource (for example, a quantity of occupied subcarriers is used for description) occupied by the preamble signal is 16 occupied subcarriers, a length of the vector corresponding to the mode 1 is 4, a length of the vector corresponding to the mode 2 is 2, a length of the vector corresponding to the mode 3 is also 2, the lengths of the vectors respectively corresponding to the mode 1, the mode 2, and the mode 3 are all factors of the 16 subcarriers occupied by the preamble signal, and a product (4×2×2=16) of the lengths of the vectors respectively corresponding to the mode 1, the mode 2, and the mode 3 is the quantity of subcarriers occupied by the preamble signal, namely, 16.

In the example shown in FIG. 10, the vector corresponding to the mode 1 is randomly selected from a vector set (referred to as a vector set 1 for differentiation), the vector corresponding to the mode 3 is randomly selected from another vector set (referred to as a vector set 3 for differentiation), and the vector corresponding to the mode 5 is randomly selected from another vector set (referred to as a vector set 5 for differentiation). Therefore, for different terminal devices, a probability of selecting a same vector from the vector set 1 is low, a probability of selecting a same vector from the vector set 3 is also low, and a probability of selecting a same vector from the vector set 5 is also low. Therefore, a probability that different terminal devices select a same vector corresponding to the mode 1, a same vector corresponding to the mode 3, and a same vector corresponding to the mode 5 is low. In this way, a probability that different terminal devices select a same vector to generate a preamble sequence is reduced, thereby reducing a probability of interference or a collision between preamble sequences of different terminal devices, and improving quality and efficiency of communication.

In the example shown in FIG. 10, a time domain resource (a quantity of occupied symbols is used as an example for description) occupied by the preamble signal is 24 occupied symbols, a length of the vector corresponding to the mode 4 is 6, a length of the vector corresponding to the mode 5 is 4, and the lengths of the vectors respectively corresponding to the mode 4 and the mode 5 are both factors of the 24 symbols occupied by the preamble signal. In addition, a product (6×4=24) of the lengths of the vectors respectively corresponding to the mode 4 and the mode 5 is the quantity of symbols occupied by the preamble signal, namely, 24.

Optionally, after receiving the preamble signal, the network device may further perform S950 to S970.

S950: The network device obtains the preamble sequence based on the preamble signal, and performs Kronecker product decomposition on the preamble sequence to obtain the vectors respectively corresponding to the mode 1 to the mode 5. The lengths of the vectors respectively corresponding to the mode 1, the mode 2, and the mode 3 are determined based on the frequency domain resource occupied by the preamble signal. The lengths of the vectors respectively corresponding to the mode 4 and the mode 5 may be determined based on the time domain resource occupied by the preamble signal.

For a relationship between the frequency domain resource occupied by the preamble signal and the lengths of the vectors respectively corresponding to the mode 1, the mode 2, and the mode 3, refer to the foregoing descriptions. For a relationship between the time domain resource occupied by the preamble signal and the lengths of the vectors respectively corresponding to the mode 4 and the mode 5, refer to the foregoing descriptions. For brevity, details are not described herein again.

S960: The network device performs time domain estimation by using the vector corresponding to the mode 2 to obtain a time domain offset estimation value, and performs frequency domain offset estimation by using the vector corresponding to the mode 4 to obtain a frequency domain offset estimation value.

For example, with reference to the foregoing example, the network device may perform time domain offset estimation by using the vector corresponding to the mode 2 to obtain a time domain offset estimation value, and perform frequency domain offset estimation by using the vector corresponding to the mode 4 to obtain a frequency domain offset estimation value.

S970: The network device performs time offset and frequency offset adjustment on a subsequently received signal based on the time domain offset estimation value and the frequency domain offset estimation value, to complete a subsequent random access process.

For example, the network device may perform, based on the time domain offset estimation value and the frequency domain offset estimation value, time domain and frequency domain adjustment on the signal subsequently received in the random access process. This ensures random access efficiency and precision, to resolve an asynchronization problem in the random access process in which the preamble sequence generated by using the Kronecker product of the K vectors is used.

According to the information transmission method provided in this embodiment of this disclosure, based on a manner of obtaining the preamble sequence by using the product of the K (for example, five) vectors, a large quantity of preamble sequences can be generated, thereby improving efficiency of communication using the preamble. In addition, in a vector corresponding to a generation parameter that is preconfigured by the network device and that is of the vector, a length of a part of the vector is determined based on a frequency domain resource occupied by a preamble signal, and a length of a part of the vector is determined based on a time domain resource occupied by the preamble signal. Time domain offset estimation and frequency domain offset estimation are performed by using the vector corresponding to the generation parameter that is preconfigured by the network device and that is of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

Optionally, in another implementation of this disclosure, S950 to S970 may be all performed by the RU, or may be all performed by the DU, or may be performed by the RU and the DU through collaboration.

When the RU collaborates with the DU, for example, after receiving the preamble signal, the RU may perform S950 to send the obtained vectors respectively corresponding to the mode 1 to the mode 5 to the DU, and then the DU performs S960 and S970. For another example, after receiving the preamble signal, the RU may perform S950 and S960 to send the obtained time domain offset estimation value and frequency domain offset estimation value to the DU, and then the DU performs S970.

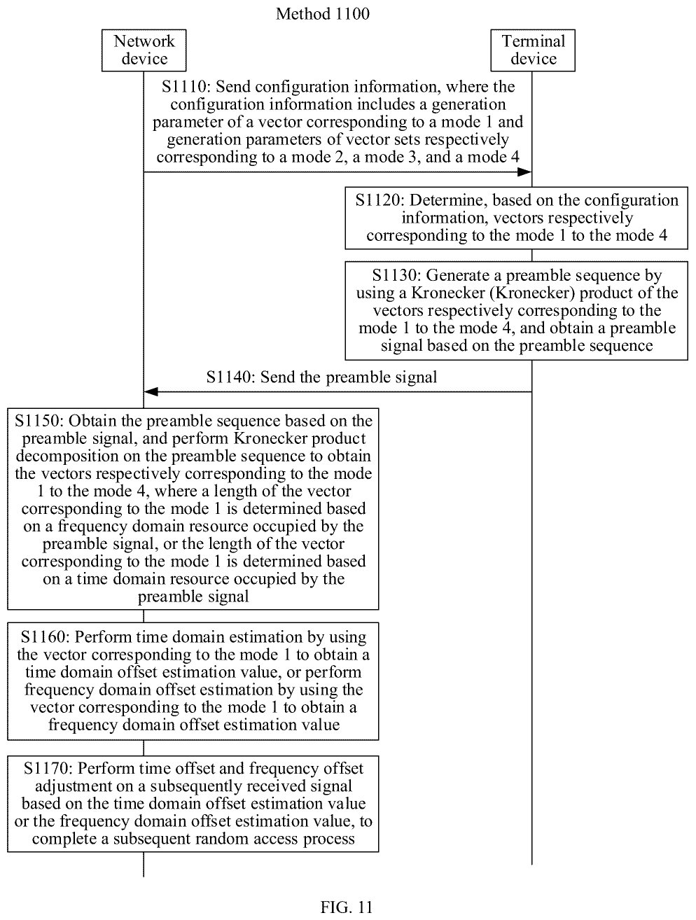

FIG. 11 is a schematic interaction diagram of an information transmission method according to another embodiment of this disclosure. As shown in FIG. 11, the method 1100 shown in FIG. 11 may include S1110 to S1170. The following describes each step in the method 1100 in detail with reference to FIG. 11.

S1110: A network device sends configuration information to a terminal device, where the configuration information includes a generation parameter of a vector corresponding to a mode 1 and generation parameters of vector sets respectively corresponding to a mode 2, a mode 3, and a mode 4.

In other words, the configuration information includes a generation parameter of one vector and generation parameters of three vector sets. The vector corresponding to the mode 1, a vector corresponding to the mode 2, a vector corresponding to the mode 3, and a vector corresponding to the mode 4 are vectors respectively corresponding to four modes or dimensions (modes) of a tensor (Tensor).

Correspondingly, the terminal device receives the configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

Optionally, in a possible implementation, the generation parameter of the vector and the generation parameters of the three vector sets are determined based on (or related to) a cell ID of the terminal device.

S1120: After receiving the configuration information, the terminal device determines, based on the configuration information, the vectors respectively corresponding to the mode 1 to the mode 4.

For specific processes of S1110 and S1120, refer to the descriptions corresponding to foregoing method. For brevity, details are not described herein again.

Optionally, in a possible implementation, a length of the vector corresponding to the mode 1 may be determined based on a frequency domain resource occupied by a preamble signal, or the length of the vector corresponding to the mode 1 may be determined based on a time domain resource occupied by the preamble signal. In other words, the generation parameter of the vector corresponding to the mode 1 may be determined based on the frequency domain resource occupied by the preamble signal, or the generation parameter of the vector corresponding to the mode 1 may be determined based on the time domain resource occupied by the preamble signal.

Optionally, in a possible implementation, one or more of a length of the vector corresponding to the mode 2, a length of the vector corresponding to the mode 3, and a length of the vector corresponding to the mode 4 may be 1. That is, one or more of the vector corresponding to the mode 2, the vector corresponding to the mode 3, and the vector corresponding to the mode 4 may be optional. In this case, in a possible implementation, the configuration information in S1110 may include: the generation parameter of the vector corresponding to the mode 1 and at least one of the generation parameters of the vector sets corresponding to the mode 2, the mode 3, and the mode 4.

S1130: The terminal device generates a preamble sequence by using a Kronecker product of the vectors respectively corresponding to the mode 1 to the mode 4, and obtains a preamble signal based on the preamble sequence.

For example, the terminal device performs Kronecker multiplication on the four vectors, that is, performs an operation of mode 4*mode 3*mode 2*mode 1, where “*” represents the Kronecker multiplication, and “mode i” represents a vector corresponding to the mode, to obtain the preamble sequence.

Optionally, the terminal device may further perform a cyclic shift on the generated preamble sequence to obtain a cyclically shifted preamble sequence, and add a cyclic prefix to the cyclically shifted preamble sequence to obtain a preamble signal, so that a quantity of available preamble sequences can be further increased. Optionally, a value of the cyclic shift may be indicated by the network device to the terminal device, or may be predefined in a protocol.

In a possible implementation, the generation parameter of the vector and/or the generation parameters of the three vector sets are determined based on (or related to) the cell ID of the terminal device. Different cells correspond to different cell IDs. Therefore, for terminal devices in different cells, four selected or determined vectors are not completely the same. Further, preamble sequences generated by using Kronecker products of the four vectors are also different. This can reduce interference between the cells and improve quality and efficiency of communication.

S1140: The terminal device sends the preamble signal to the network device.

Correspondingly, the network device receives the preamble signal, to continue completing a random access process.

In a possible implementation, when the terminal device sends the preamble, the RU may alternatively receive the preamble sent by the terminal device, to continue completing the random access process. In other words, a body that receives the preamble may alternatively be the RAN node. For example, the RAN node is the RU. After receiving the preamble signal, the RU continues completing the random access process.

In another possible implementation, when the terminal device sends the preamble, the RU may alternatively receive the preamble sent by the terminal device, and sends the preamble to the DU after performing processing (for example, noise reduction processing) on the preamble. After receiving the preamble sent by the RU, the DU continues completing the random access process. In other words, a body that finally receives the preamble may alternatively be the RAN node. For example, the RAN node is the DU.

For example, the terminal device may send the preamble signal to the network device in an OFDM waveform.

For another example, the terminal device may alternatively send the preamble signal to the network device in a DFT-s-OFDM waveform, so that a PAPR of the preamble signal can be low, thereby improving transmission efficiency of the preamble.

According to the method 1100, the preamble sequence is obtained by using the Kronecker product of the four vectors. This increases a quantity of preamble sequences, to satisfy a communication requirement of a system and improve communication efficiency. For example, a quantity of users using preamble sequences for access can be increased.

Optionally, in a possible implementation, in the method 1100, the length of the vector corresponding to the mode 1 may be determined based on the frequency domain resource occupied by the preamble signal. In other words, the first group of vectors may include the vector corresponding to the mode 1 and the vector corresponding to the mode 2, or the first group of vectors may include the vector corresponding to the mode 1. A length of a vector in the first group of vectors may be determined based on the frequency domain resource occupied by the preamble signal (or the length of each vector in the first group of vectors is related to the frequency domain resource occupied by the preamble signal). For example, the lengths of the vectors respectively corresponding to the mode 1 and the mode 2 are both factors of a quantity of subcarriers occupied by the preamble signal, and/or a product of the lengths of the vectors respectively corresponding to the mode 1 and the mode 2 is the quantity of subcarriers occupied by the preamble signal. Because the network device configures the generation parameter of the only one vector (the vector corresponding to the mode 1), there is no second group of vectors. That is, the K (four) vectors include the first group of vectors, and the first group of vectors includes the vector corresponding to the mode 1 and the vector corresponding to the mode 2. The length of the vector in the first group of vectors is determined based on the frequency domain resource occupied by the preamble.

Optionally, in another possible implementation, in the method 1100, the length of the vector corresponding to the mode 1 may be determined based on the time domain resource occupied by the preamble signal. In other words, the second group of vectors may include the vector corresponding to the mode 1 and the vector corresponding to the mode 2, or the second group of vectors may include the vector corresponding to the mode 1. A length of a vector in the second group of vectors may be determined based on the time domain resource occupied by the preamble signal (or the length of each vector in the second group of vectors is related to the time domain resource occupied by the preamble signal). For example, the lengths of the vectors respectively corresponding to the mode 1 and the mode 2 are both factors of a quantity of symbols occupied by the preamble signal, and/or a product of the lengths of the vectors respectively corresponding to the mode 1 and the mode 2 is the quantity of symbols occupied by the preamble signal. Because the network device configures the generation parameter of the only one vector (the vector corresponding to the mode 1), there is no first group of vectors. That is, the K (four) vectors include the second group of vectors, and the second group of vectors includes the vector corresponding to the mode 1 and the vector corresponding to the mode 2. The length of the vector in the second group of vectors is determined based on the time domain resource occupied by the preamble.

For example, FIG. 12 is a diagram of an example in which the terminal device generates a preamble sequence by using vectors corresponding to a mode 1 to a mode 4. In the example shown in FIG. 12, a first group of vectors includes the vector corresponding to the mode 1 and the vector corresponding to the mode 2. A length of a vector in the first group of vectors is determined based on a frequency domain resource occupied by a preamble signal (in other words, the length of each vector in the first group of vectors is related to the frequency domain resource occupied by the preamble signal).

In the example shown in FIG. 12, a resource mapping manner of the preamble signal is frequency-domain mapping (Frequency Mapping) first and then time-domain mapping (Time Mapping). The frequency domain resource (for example, a quantity of occupied subcarriers is used for description) occupied by the preamble signal is 16 occupied subcarriers, a length of the vector corresponding to the mode 1 is 4, a length of the vector corresponding to the mode 2 is 4, the lengths of the vectors respectively corresponding to the mode 1 and the mode 2 are both factors of the 16 subcarriers occupied by the preamble signal, and a product (4×4=16) of the lengths of the vectors respectively corresponding to the mode 1 and the mode 2 is the quantity of subcarriers occupied by the preamble signal, namely, 16.

In the example shown in FIG. 12, the vector corresponding to the mode 2 is randomly selected from a vector set (referred to as a vector set 2 for differentiation), the vector corresponding to the mode 3 is randomly selected from another vector set (referred to as a vector set 3 for differentiation), and the vector corresponding to the mode 4 is randomly selected from another vector set (referred to as a vector set 4 for differentiation). In this case, for different terminal devices, a probability of selecting a same vector from the vector set 2 is low, a probability of selecting a same vector from the vector set 3 is also low, and a probability of selecting a same vector from the vector set 4 is also low. Therefore, a probability that different terminal devices select same vectors corresponding to the mode 2 to the mode 4 is low. In this way, a probability that different terminal devices select a same vector to generate a preamble sequence is reduced, thereby reducing a probability of interference or a collision between preamble sequences of different terminal devices, and improving quality and efficiency of communication.

Optionally, after receiving the preamble signal, the network device may further perform S1150 to S1170.

S1150: The network device obtains the preamble sequence based on the preamble signal, and performs Kronecker product decomposition on the preamble sequence to obtain the vectors respectively corresponding to the mode 1 to the mode 4. The length of the vector corresponding to the mode 1 is determined based on the frequency domain resource occupied by the preamble signal, or the length of the vector corresponding to the mode 1 is determined based on the time domain resource occupied by the preamble signal.

For example, the length of the vector corresponding to the mode 1 is the factor of the quantity of subcarriers occupied by the preamble signal, or the length of the vector corresponding to the mode 1 is the factor of the quantity of symbols occupied by the preamble signal.

S1160: The network device performs time domain estimation by using the vector corresponding to the mode 1 to obtain a time domain offset estimation value, or performs frequency domain offset estimation by using the vector corresponding to the mode 1 to obtain a frequency domain offset estimation value.

For example, if the length of the vector corresponding to the mode 1 is determined based on the frequency domain resource occupied by the preamble signal, the network device may perform time domain estimation by using the vector corresponding to the mode 1, to obtain the time domain offset estimation value. If the length of the vector corresponding to the mode 1 is determined based on the time domain resource occupied by the preamble signal, the network device may perform frequency domain estimation by using the vector corresponding to the mode 1, to obtain the frequency domain offset estimation value.

S1170: The network device performs time offset and frequency offset adjustment on a subsequently received signal based on the time domain offset estimation value or the frequency domain offset estimation value, to complete a subsequent random access process.

For example, the network device may perform, based on the time domain offset estimation value or the frequency domain offset estimation value, time domain or frequency domain adjustment on the signal subsequently received in the random access process. This ensures random access efficiency and precision, to resolve an asynchronization problem in the random access process in which the preamble sequence generated by using the Kronecker product of the K vectors is used.

According to the information transmission method provided in this embodiment of this disclosure, based on a manner of obtaining the preamble sequence by using the product of the K (for example, four) vectors, a large quantity of preamble sequences can be generated, thereby improving efficiency of communication using the preamble. In addition, in a vector corresponding to a generation parameter that is preconfigured by the network device and that is of the vector, a length of the vector is determined based on a frequency domain resource occupied by a preamble signal, or is determined based on a time domain resource occupied by the preamble signal. Time domain offset estimation or frequency domain offset estimation is performed by using the vector corresponding to the generation parameter that is preconfigured by the network device and that is of the vector, to perform time domain or frequency domain adjustment on a signal subsequently received in the random access process. This ensures random access efficiency and precision, to resolve an asynchronization problem in the random access process in which the preamble sequence generated by using the product of the K vectors is used.

Optionally, in another implementation of this disclosure, 51150 to S1170 may be all performed by the RU, or may be all performed by the DU, or may be performed by the RU and the DU through collaboration.

When the RU collaborates with the DU, for example, after receiving the preamble signal, the RU may perform S1150 to send the obtained vectors respectively corresponding to the mode 1 to the mode 4 to the DU, and then the DU performs S1160 and S1170. For another example, after receiving the preamble signal, the RU may perform S1150 and S1160 to send the obtained time domain offset estimation value or frequency domain offset estimation value to the DU, and then the DU performs S1170.

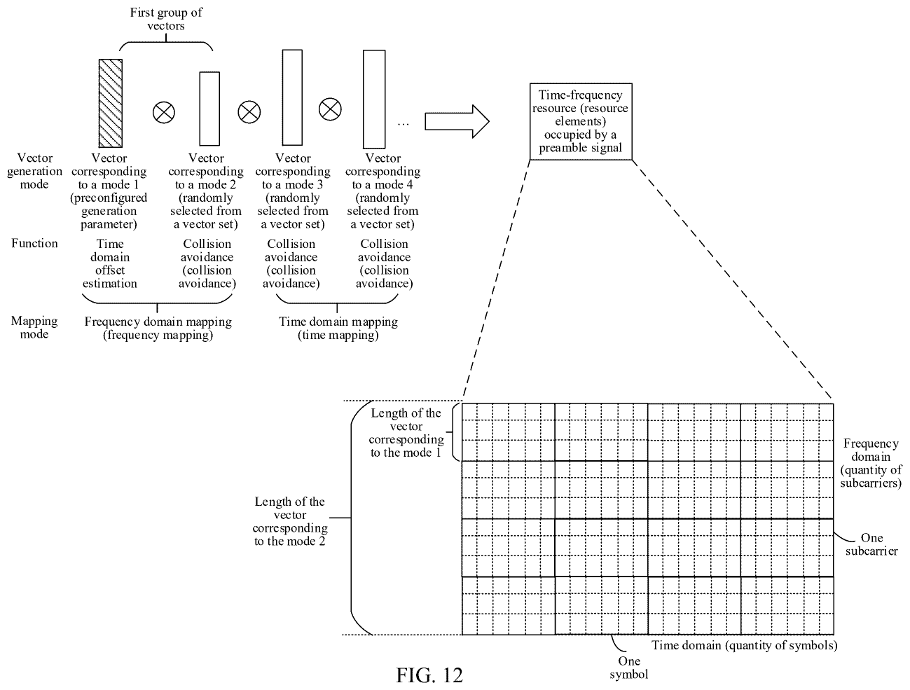

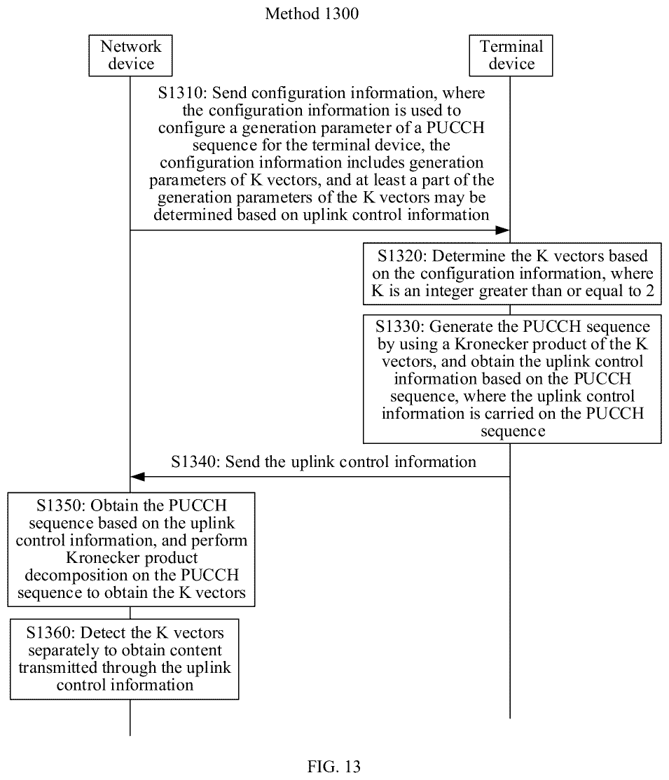

FIG. 13 is a schematic interaction diagram of an information transmission method according to an embodiment of this disclosure. As shown in FIG. 13, the method 1300 shown in FIG. 13 may include S1300 to S1360. The following describes each step in the method 1300 in detail with reference to FIG. 13.

S1310: A network device sends configuration information to a terminal device, where the configuration information is used to configure a generation parameter of a PUCCH sequence for the terminal device. The configuration information includes generation parameters of K vectors, and at least a part of the generation parameters of the K vectors may be determined based on uplink control information.

Correspondingly, the terminal device receives the configuration information.

In a possible implementation, an RU may generate the configuration information and send the configuration information to the terminal device. In other words, a body for generating and sending the configuration information may be a RAN node. For example, the RAN node may be the RU.

In another possible implementation, a DU may generate the configuration information, and the DU sends the configuration information to an RU. Finally, the RU sends the configuration information to the terminal device.

For example, the network device or the RAN node may send the configuration information to the terminal device through RRC signaling or a MAC CE. Certainly, in another implementation of this disclosure, the network device may further send the configuration information to the terminal device through other higher layer signaling or physical layer signaling. This is not limited herein in this embodiment of this disclosure.

In some embodiments, the configuration information is used by the terminal device to determine the K vectors, and the terminal device may generate or obtain the PUCCH sequence by using a product of the K vectors, where K is an integer greater than or equal to 2.

Optionally, in a possible implementation, the configuration information may include the generation parameters of the K vectors. For example, it is assumed that K is equal to 4, that is, the configuration information is used by the terminal device to determine four vectors.

In this embodiment of this disclosure, the at least part of the generation parameters of the K vectors may be determined based on the uplink control information. For example, the uplink control information may include an SR, an ACK, a CQI, and the like. In other words, the at least part of the generation parameters of the K vectors are related to content (type) of the uplink control information, or are related to a value of a bit occupied by the uplink control information (or a value of the uplink control information). If content of the uplink control information is different, values of bits occupied by the uplink control information (or values of the uplink control information) are different. The SR, the ACK, the CQI, and the like may be understood as different content or types of the uplink control information. For example, the value of the uplink control information when the uplink control information is the SR is different from the value of the uplink control information when the uplink control information is the ACK. All the generation parameters of the K vectors corresponding to the uplink control information being the SR are all different from or not completely the same as all the generation parameters of the K vectors corresponding to the uplink control information being the ACK. That all the generation parameters are not completely the same may be understood as that a part of the generation parameters of the K vectors corresponding to the SR are the same as a part of the generation parameters of the K vectors corresponding to the ACK, and a part of the generation parameters of the K vectors corresponding to the SR are different from a part of the generation parameters of the K vectors corresponding to the ACK. That all the generation parameters are different may be understood as that there is no same generation parameter in the generation parameters of the K vectors corresponding to the SR and the generation parameters of the K vectors corresponding to the ACK, that is, there is no intersection.

S1320: After receiving the configuration information, the terminal device determines the K vectors based on the configuration information, where K is an integer greater than or equal to 2.

For example, if the configuration information includes the generation parameters of the K vectors, after receiving the configuration information, the terminal device may generate or determine the K vectors based on the generation parameters of the K vectors and different uplink control information, where K is an integer greater than or equal to 2.

The following describes, with reference to a specific example, a process of generating the K vectors based on the generation parameters of the K vectors and the uplink control information.

For example, it is assumed that a generation parameter of one of the K vectors is a generation parameter of an S^{th} vector, and T and F are respectively a time domain parameter and a frequency domain parameter of PUCCH resource mapping. In this case, the S^{th} vector may be obtained in the following manners.

In a possible implementation, the S^{th} vector is generated according to a preset rule by using the generation parameter of the S^{th} vector, a value of the uplink control information, T, and F. The preset rule may be predefined in a protocol or configured by the network device. There may be a plurality of preset rules. For example, a possible rule may include the following three steps:

Step 1: First, a sequence Z(i) is generated based on the generation parameter of the S^{th} vector, T, and F, where a value of i is 0, 1, . . . , N, and N is a length of the sequence Z(i).

Step 2: Assuming that a length of the uplink control information is n bits, there are 2ⁿ possible values of the uplink control information, and each different value corresponds to a different cyclic shift value.

Step 3: All cyclic shift values are applied to the sequence Z(i) to obtain a new sequence Z′(i), where the new sequence Z′(i) is the S^{th} vector. For example, the new sequence Z′(i) may satisfy Formula (6):

$$Z \cdot ( i ) = Z ( i ) \cdot {e}^{( j \times 2 \times π / N \times c )} \qquad ( 6 )$$

In Formula (6), c represents the cyclic shift value, N is the length of the sequence Z(i), and j represents an imaginary unit, where j=sprt(−1), and sprt(−1) represents a square root of a real number −1.

In another possible implementation, error correction coding is performed on all or a part of bits in the uplink control information. For example, error correction coding may be performed by using a low-density parity-check (LDPC) code, a polar code, or a Reed Muller (RM) code, to obtain an encoded binary vector (or may be referred to as a binary sequence). Optionally, a scrambling vector may be further generated based on the generation parameter of the S^{th} vector and the parameters of PUCCH resource mapping (including T and F, where T and F are respectively the time domain parameter and the frequency domain parameter of PUCCH resource mapping), and the encoded binary vector is scrambled by using the scrambling vector, to obtain a scrambled binary vector. Then, the binary vector or the scrambled binary vector is modulated. For example, a modulation scheme like binary phase shift keying (BPSK) or quadrature phase shift keying (QPSK) is used, to obtain a modulated vector, namely, the S^{th} vector.

In still another possible implementation, a table may be predefined in a protocol, and the table includes 2^{m} vectors. The vector in the table may be a binary bit vector, or may be a modulated complex vector. m bits are selected from the uplink control information, and one of 2^{m} vectors is selected based on 2^{m} possible values of the m bits.

If the vector in the table is the binary bit vector, one of the binary bit vectors is selected from the table. Optionally, a scrambling vector may be further generated based on the generation parameter of the S^{th} vector and the parameters of PUCCH resource mapping (including T and F, where T and F are respectively the time domain parameter and the frequency domain parameter of PUCCH resource mapping), and the selected binary bit vector is scrambled by using the scrambling vector, to obtain a scrambled binary bit vector. Then, a bit or a bit group in the selected binary bit vector or the scrambled binary bit vector is modulated, and the modulated vector is the S^{th} vector.

If the vector in the table is the complex vector, one complex vector is selected from the table. Optionally, a scrambling vector may be further generated based on the generation parameter of the S^{th} vector and the parameters of PUCCH resource mapping (including T and F, where T and F are respectively the time domain parameter and the frequency domain parameter of PUCCH resource mapping), and the selected complex vector is scrambled by using the scrambling vector, to obtain a scrambled complex vector. The selected complex vector or the scrambled complex vector in the table is the S^{th} vector.

It should be understood that the foregoing is merely an example of a process of generating a vector based on a generation parameter of the vector and the value of the uplink control information. In another implementation of this disclosure, a vector may alternatively be obtained in another manner based on a generation parameter of the vector and the value of the uplink control information. This is not limited herein in this embodiment of this disclosure.

S1330: The terminal device generates the PUCCH sequence by using a Kronecker product of the K vectors, and obtains the uplink control information based on the PUCCH sequence. The uplink control information is carried on the PUCCH sequence.

It should be understood that the uplink control information is sent on a PUCCH or the PUCCH sequence, or content carried (or transmitted) on the PUCCH or the PUCCH sequence is the uplink control information. The PUCCH may be obtained by performing a cyclic shift value on the PUCCH sequence.

For example, the terminal device may perform Kronecker multiplication on the K vectors to obtain a Kronecker multiplication result of the K vectors, that is, obtain the PUCCH sequence.

For example, it is assumed that K is equal to 5. The terminal device performs the Kronecker multiplication on the five vectors, that is, performs an operation of mode 5*mode 4*mode 3*mode 2*mode 1, where “*” represents the Kronecker multiplication, and “mode i” represents a vector corresponding to an i^{th} mode or dimension of the tensor, to obtain the PUCCH sequence.

It should be understood that, in this embodiment of this disclosure, in addition to generating the PUCCH sequence by using the Kronecker product of the K vectors, the PUCCH sequence may alternatively be generated by using another product of the K vectors. A specific manner of the product of the K vectors is not limited in this disclosure.

Optionally, in a possible implementation, the terminal device may further perform a cyclic shift on the generated PUCCH sequence, to obtain a cyclically shifted PUCCH sequence, and include (or transmit) uplink control information on the cyclically shifted PUCCH sequence, to further increase a quantity of available PUCCH sequences. A value of the cyclic shift may be related to different uplink control information. In other words, the value of the cyclic shift is related to a value of a bit occupied by the uplink control information (or a value of the uplink control information). For example, the value of the uplink control information when the uplink control information is an SR is different from the value of the uplink control information when the uplink control information is an ACK. The value of the cyclic shift corresponding to the uplink control information being the SR is different from the value of the cyclic shift corresponding to the uplink control information being the ACK. The SR and the ACK may be understood as different uplink control information.

S1340: The terminal device sends the uplink control information to the network device.

Correspondingly, the network device receives the uplink control information, to complete transmission (or feedback) of the uplink control information by using the PUCCH sequence.

In a possible implementation, when the terminal device sends the uplink control information, the RU may alternatively receive the uplink control information sent by the terminal device. In other words, a body that receives the uplink control information may alternatively be the RAN node. For example, the RAN node is the RU. After receiving the uplink control information, the RU obtains content of the uplink control information.

In another possible implementation, when the terminal device sends the uplink control information, the RU may alternatively receive the uplink control information sent by the terminal device, and send the uplink control information to the DU after processing (for example, performing noise reduction processing on) the uplink control information. After receiving the uplink control information sent by the RU, the DU obtains content of the uplink control information. In other words, a body that finally receives the uplink control information may alternatively be the RAN node. For example, the RAN node is the DU. The DU obtains the content of the uplink control information.

For example, the terminal device may send the uplink control information to the network device in an OFDM waveform.

For another example, the terminal device may alternatively send the uplink control information to the network device in a DFT-s-OFDM waveform. In this way, a PAPR of the uplink control information can be low, and transmission efficiency of the uplink control information can be improved.

S1350: The network device obtains the PUCCH sequence based on the uplink control information, and performs Kronecker product decomposition on the PUCCH sequence to obtain the K vectors.

For example, after receiving the uplink control information carried (or transmitted) on the PUCCH sequence, the network device decomposes the PUCCH sequence to obtain the K vectors, where K is an integer greater than or equal to 2.

S1360: The network device detects the K vectors separately to obtain the content transmitted through the uplink control information.

In this embodiment of this disclosure, because the at least part of the generation parameters of the K vectors are determined based on the uplink control information, the generation parameters of the K vectors may be used to generate the K vectors. In other words, the K vectors are determined based on the uplink control information, or the K vectors are related to the uplink control information. For example, the K vectors corresponding to the uplink control information being the SR are different from or not completely the same as the K vectors corresponding to the uplink control information being the ACK. In other words, the K vectors corresponding to each piece of content of different uplink control information (for example, the SR, the ACK, and a CQI) are all different or not completely the same, or the content of the uplink control information (for example, the SR, the ACK, or the CQI) is carried on the K vectors. Therefore, after obtaining the K vectors, the network device may detect the K vectors to obtain the content transmitted through the uplink control information transmission.

For example, when the at least part of the generation parameters of the K vectors are determined based on the SR, the network device may detect the K vectors to obtain the SR.

For another example, when the at least part of the generation parameters of the K vectors are determined based on the ACK, the network device may detect the K vectors to obtain the ACK.

According to the information transmission method provided in this embodiment of this disclosure, the PUCCH sequence is obtained by using the product (for example, the Kronecker product) of the K vectors, and the quantity of generated PUCCH sequences is increased. This can improve a capability and reliability of transmitting the uplink control information on the PUCCH sequence.

Optionally, in another implementation of this disclosure, S1350 and S1360 may be both performed by the RU, or may be both performed by the DU, or may be performed by the RU and the DU through collaboration.

When the RU collaborate with the DU, for example, after receiving the uplink control information, the RU may perform 51350 to send the obtained K vectors to the DU, and then the DU performs 51360.

It should be understood that the foregoing descriptions are merely intended to help a person skilled in the art better understand embodiments of this disclosure, but are not intended to limit the scope of embodiments of this disclosure. It is clear that a person skilled in the art may make various equivalent modifications or changes based on the foregoing examples. For example, some steps in the foregoing method embodiments may be unnecessary, or some steps may be newly added. Alternatively, any two or more of the foregoing embodiments are combined. Such a modified, changed, or combined solution also falls within the scope of embodiments of this disclosure.

It should be further understood that division into manners, cases, categories, and embodiments in embodiments of this disclosure is merely intended for ease of description, and should not constitute a particular limitation. The features in the manners, categories, cases, and embodiments may be combined without contradiction.

It should be further understood that various numbers used in embodiments of this disclosure are merely distinguished for ease of description, but are not intended to limit the scope of embodiments of this disclosure. The sequence numbers of the foregoing processes do not mean execution sequences. The execution sequences of the processes should be determined based on functions and internal logic of the processes, and should not constitute any limitation on implementation processes of embodiments of this disclosure.

It should be further understood that the foregoing descriptions of embodiments of this disclosure emphasize differences between the embodiments. For same or similar parts that are not mentioned, refer to these embodiments. For brevity, details are not described herein again.

It should be further understood that in embodiments of this disclosure, “predefine” or “preset” may be implemented by pre-storing corresponding code, a table, or another manner for indicating related information in a device. A specific implementation thereof is not limited in this disclosure.

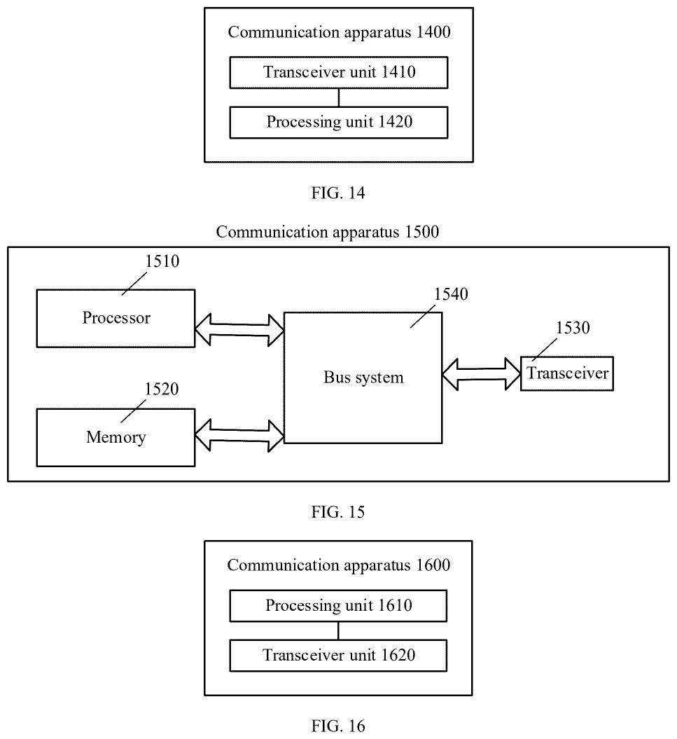

The foregoing describes in detail the information transmission method in embodiments of this disclosure with reference to FIG. 1 to FIG. 13. The following describes in detail the communication apparatuses in embodiments of this disclosure with reference to FIG. 14 to FIG. 19.

In the embodiments, a terminal device and a network device may be divided into functional modules based on the foregoing method. For example, each functional module may be obtained through division based on each corresponding function, or two or more functions may be integrated into one processing module. The integrated module may be implemented in a form of hardware. It should be noted that the module division in the embodiments is an example and is merely logical function division. During actual implementation, there may be another division manner.

It should be noted that related content of the steps in the foregoing method embodiments may be referenced to function descriptions of corresponding functional modules, and details are not described herein again.

The terminal device and the network device provided in embodiments of this disclosure are configured to perform any one of the information transmission methods provided in the foregoing method embodiments. Therefore, effects that are the same as those of the foregoing implementation method can be achieved. When an integrated unit is used, the terminal device or the network device may include a processing module, a storage module, and a communication module. The processing module may be configured to control and manage an action of the terminal device or the network device. For example, the processing unit may be configured to support the terminal device or the network device in performing a step performed by a processing unit. The storage module may be configured to support storage of program code, data, and the like. The communication module may be configured to support the terminal device or the network device in communicating with another device.

The processing module may be a processor or a controller. The processor may implement or execute various example logical blocks, modules, and circuits described with reference to content disclosed in this disclosure. The processor may alternatively be a combination implementing a computing function, for example, including a combination of one or more microprocessors, or a combination of a digital signal processor (DSP) and a microprocessor. The storage module may be a memory. The communication module may be specifically a device that interacts with another electronic device, for example, a radio frequency circuit, a Bluetooth chip, or a Wi-Fi chip.

For example, FIG. 14 is a schematic block diagram of a communication apparatus 1400 according to an embodiment of this disclosure. The communication apparatus 1400 may correspond to the terminal device described in the method 400, the method 500, the method 700, the method 900, the method 1100, or the method 1300, or may be a chip or a component used in the terminal device. In addition, modules or units in the communication apparatus 1400 are separately configured to perform actions or processing processes performed by the terminal device in the method 400, the method 500, the method 700, the method 900, the method 1100, or the method 1300.

As shown in FIG. 14, the communication apparatus 1400 includes a transceiver unit 1410 and a processing unit 1420. The transceiver unit 1410 is configured to send or receive a specific signal under driving of the processing unit 1420.

The processing unit 1420 is configured to generate a preamble sequence or a PUCCH sequence by using K vectors, where K is an integer greater than or equal to 2.

The transceiver unit 1410 is configured to: send a preamble based on the preamble sequence, or send uplink control information based on the PUCCH sequence.

The communication apparatus provided in this disclosure generates the preamble sequence, the PUCCH sequence, or the like by using a product (for example, a Kronecker product) of a plurality of vectors, to increase a quantity of generated preamble sequences or PUCCH sequences, so as to satisfy a communication requirement of a system and improve communication efficiency. For example, for the preamble sequence, a quantity of users using the preamble sequence for access can be increased in a random access process. For the PUCCH sequence, a capability and reliability of transmitting the uplink control information through the PUCCH sequence can also be improved.

In some possible implementations, before the preamble sequence is generated by using the K vectors, the transceiver unit 1410 is further configured to receive configuration information. The configuration information includes a generation parameter of K₁ vectors and a generation parameter of K₂ vector sets. The processing unit 1420 is further configured to: generate the K₁ vectors based on the generation parameter of the K₁ vectors; generate the K₂ vector sets based on the generation parameter of the K₂ vector sets; and select one vector from each of the K₂ vector sets to obtain the K₂ vectors, where the K vectors include the K₁ vectors and the K₂ vectors. In this implementation, the generation parameter of the K₁ vectors and the generation parameter of the K₂ vector sets are configured for the communication apparatus through the configuration information, so that efficiency of determining the K vectors by the communication apparatus can be improved. In addition, overheads of the configuration information are low, and consumption of communication resources is reduced.

In some possible implementations, before the preamble sequence is generated by using the K vectors, the transceiver unit 1410 is further configured to receive configuration information. The configuration information includes generation parameters of the K vectors or generation parameters of K vector sets. The processing unit 1420 is further configured to: generate the K vectors based on the generation parameters of the K vectors; or generate the K vector sets based on the generation parameters of the K vector sets, and select one vector from each of the K vector sets to obtain the K vectors. In this implementation, the generation parameters of the K vectors or the generation parameters of the K vector sets are configured for the communication apparatus through the configuration information, so that efficiency of determining the K vectors by the communication apparatus can be improved. In addition, overheads of the configuration information are low, and consumption of communication resources is reduced.

In some possible implementations, the K vectors include a first group of vectors and/or a second group of vectors. The first group of vectors includes at least one of the K₁ vectors or at least one of the K vectors generated by using the generation parameters of the K vectors. The second group of vectors includes at least one of the K₁ vectors or at least one of the K vectors generated by using the generation parameters of the K vectors. A length of a vector in the first group of vectors is determined based on a frequency domain resource occupied by the preamble, and a length of a vector in the second group of vectors is determined based on a time domain resource occupied by the preamble. In this implementation, in a vector corresponding to a preconfigured generation parameter of the vector, a length of the vector is determined based on the frequency domain resource occupied by the preamble signal, and/or the length of the vector is determined based on the time domain resource occupied by the preamble signal. Therefore, the communication apparatus receiving the preamble signal may perform time domain offset estimation and/or frequency domain offset estimation by using the vector corresponding to the preconfigured generation parameter of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

In some possible implementations, the length of the vector in the first group of vectors satisfies at least one of the following conditions: the length of each vector in the first group of vectors is a factor of a quantity of subcarriers occupied by the preamble, and a product of the lengths of the vectors in the first group of vectors is the quantity of subcarriers occupied by the preamble; and/or the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble. In this implementation, the first group of vectors is mapped to the frequency domain resource occupied by the preamble, the second group of vectors is mapped to the time domain resource occupied by the preamble, and the first group of vectors and/or the second group of vectors satisfy/satisfies the foregoing conditions. Therefore, this can improve efficiency of mapping the first group of vectors and/or the second group of vectors to the time frequency resource of the preamble. In addition, precision of time domain offset estimation and/or frequency domain offset estimation can be improved.

In some possible implementations, at least one of the generation parameter of the K₁ vectors, the generation parameter of the K₂ vector sets, the generation parameters of the K vectors, or the generation parameters of the K vector sets is determined based on a cell ID. In this implementation, for the communication apparatus in different cells, the selected or determined K vectors are not completely the same. Further, preamble sequences generated by using products of the K vectors are also different. This can reduce interference between cells and improve quality and efficiency of communication.

In some possible implementations, before the PUCCH sequence is generated by using the K vectors, the transceiver unit 1410 is further configured to receive configuration information. The configuration information includes generation parameters of the K vectors, and at least a part of the generation parameters of the K vectors are determined based on the uplink control information. The processing unit 1420 is further configured to determine the K vectors based on the generation parameters of the K vectors. In this implementation, efficiency of determining the K vectors by the communication apparatus can be improved. In addition, overheads of the configuration information are low, and consumption of communication resources is reduced. In addition, a capability and reliability of transmitting the uplink control information through the PUCCH sequence can be improved.

In some possible implementations, the processing unit 1420 is further configured to perform a cyclic shift on the preamble sequence or the PUCCH sequence, to obtain a cyclically shifted preamble sequence or a cyclically shifted PUCCH sequence. The transceiver unit 1410 is further configured to: send the preamble based on the cyclically shifted preamble sequence, or send the uplink control information based on the cyclically shifted PUCCH sequence. In this implementation, a quantity of available preamble sequences or PUCCH sequences can be further increased, to increase a quantity of generated preamble sequences or PUCCH sequences.

In some possible implementations, the processing unit 1420 is further configured to generate the preamble sequence or the PUCCH sequence by using a Kronecker product of the K vectors. In this implementation, efficiency of obtaining the preamble sequence or the PUCCH sequence can be improved. This implementation is simple, and computing resources are saved.

In some possible implementations, the preamble or the uplink control information is sent in an OFDM waveform or a DFT-s-OFDM waveform. In this implementation, the DFT-s-OFDM waveform is used, so that a PAPR of the preamble signal can be low, thereby improving transmission efficiency of the preamble.

Further, the communication apparatus 1400 may further include a storage unit. The transceiver unit 1410 may be a transceiver, an input/output interface, or an interface circuit. The storage unit is configured to store instructions executed by the transceiver unit 1410 and the processing unit 1420. The transceiver unit 1410, the processing unit 1420, and the storage unit are coupled to each other. The storage unit stores the instructions. The processing unit 1420 is configured to execute the instructions stored in the storage unit. The transceiver unit 1410 is configured to send or receive the specific signal under driving of the processing unit 1420.

It should be understood that for a specific process in which the units in the communication apparatus 1400 perform the foregoing corresponding steps, refer to the foregoing descriptions related to the terminal device in the related embodiments of the method 400, the method 500, the method 700, the method 900, the method 1100, or the method 1300. For brevity, details are not described herein again.

It should be understood that the transceiver unit 1410 may be a transceiver, an input/output interface, or an interface circuit. The storage unit may be a memory. The processing unit 1420 may be implemented by a processor. As shown in FIG. 15, a communication apparatus 1500 may include a processor 1510, a memory 1520, a transceiver 1530 (the transceiver may include a transmitter and a receiver), and a bus system 1540. The components of the communication apparatus 1500 are coupled together through the bus system 1540. In addition to a data bus, the bus system 1540 may further include a power bus, a control bus, a status signal bus, and the like. However, for clear description, various buses are marked as the bus system 1540 in FIG. 15. For ease of illustration, the bus system 1504 is merely schematically drawn in FIG. 15.

It should be understood that, when the communication apparatus 1500 is a chip, the communication apparatus 1500 may include a processor 1510 and a transceiver 1530. The transceiver 1530 may correspond to the input and output interfaces. For example, the transceiver 1530 may include the input interface and the output interface. Alternatively, the transceiver 1530 may correspond to the interface circuit. The interface circuit is configured to output and/or input a signal.

The communication apparatus 1400 shown in FIG. 14 or the communication apparatus 1500 shown in FIG. 15 can implement the steps performed by the terminal device in the embodiment of the method 400, the method 500, the method 700, the method 900, method 1100, or the method 1300. For similar descriptions, refer to the descriptions in the foregoing corresponding methods. To avoid repetition, details are not described herein again.

It should be further understood that the communication apparatus 1400 shown in FIG. 14 or the communication apparatus 1500 shown in FIG. 15 may be the terminal device.

Alternatively, the terminal device may include the communication apparatus 1400 shown in FIG. 14 or the communication apparatus 1500 shown in FIG. 15.

It should be further understood that the terminal device in this disclosure may alternatively be a chip, a chip system, a processor, or the like that supports the terminal device in implementing the method. This is not limited in embodiments of this disclosure.

FIG. 16 is a schematic block diagram of a communication apparatus 1600 according to an embodiment of this disclosure. The communication apparatus 1600 may correspond to the network device or the RAN node described in the method 400, the method 500, the method 700, the method 900, the method 1100, or the method 1300, or may be a chip or a component used in the network device or the RAN node. In addition, modules or units in the communication apparatus 1600 are separately configured to perform actions or processing processes performed by the network device or the RAN node in the method 400, the method 500, the method 700, the method 900, the method 1100, or the method 1300.

As shown in FIG. 16, the communication apparatus 1600 may include a processing unit 1610 and a transceiver unit 1620. The transceiver unit 1620 is configured to send or receive a specific signal under driving of the processing unit 1610.

The transceiver unit 1620 is configured to receive a preamble or uplink control information.

The processing unit 1610 is configured to determine a preamble sequence or a PUCCH sequence based on the preamble or the uplink control information. The preamble sequence or the PUCCH sequence is generated by using a product of K vectors, and K is an integer greater than or equal to 2.

Based on the communication apparatus provided in this disclosure, the preamble sequence or the PUCCH sequence is generated by using a product (for example, a Kronecker product) of a plurality of vectors. This can increase a quantity of generated preamble sequences or PUCCH sequences, to satisfy a communication requirement of a system and improve communication efficiency. For example, for the preamble sequence, a quantity of users using the preamble sequence for access can be increased in a random access process. For the PUCCH sequence, a capability and reliability of transmitting the uplink control information through the PUCCH sequence can also be improved.

In some possible implementations, before receiving the preamble, the transceiver unit 1620 is further configured to send configuration information. The configuration information is used to generate the preamble sequence. The configuration information includes a generation parameter of K₁ vectors and a generation parameter of K₂ vector sets, the generation parameter of the K₁ vectors is used to generate the K₁ vectors, the generation parameter of the K₂ vector sets is used to generate the K₂ vector sets, the K₂ vector sets include K₂ vectors, and the K vectors include the K₁ vectors and the K₂ vectors. In this implementation, the generation parameter of the K₁ vectors and the generation parameter of the K₂ vector sets are configured for a terminal device through the configuration information, so that efficiency of determining the K vectors by the terminal device can be improved. In addition, overheads of the configuration information are low, and consumption of communication resources is reduced.

In some possible implementations, before receiving the preamble, the transceiver unit 1620 is further configured to send configuration information. The configuration information is used to generate the preamble. The configuration information includes generation parameters of the K vectors or generation parameters of K vector sets, the generation parameters of the K vectors are used to generate the K vectors, or the generation parameters of the K vector sets are used to generate the K vector sets and the K vector sets include the K vectors. In this implementation, the generation parameters of the K vectors or the generation parameters of the K vector sets are configured for a terminal device through the configuration information, so that efficiency of determining the K vectors by the terminal device can be improved. In addition, overheads of the configuration information are low, and consumption of communication resources is reduced.

In some possible implementations, the processing unit 1610 is further configured to: decompose the preamble sequence to obtain the K vectors, where the K vectors include a first group of vectors and/or a second group of vectors; the first group of vectors includes at least one of the K₁ vectors or at least one of the K vectors generated by using the generation parameters of the K vectors; the second group of vectors includes at least one of the K₁ vectors or at least one of the K vectors generated by using the generation parameters of the K vectors; a length of a vector in the first group of vectors is determined based on a frequency domain resource occupied by the preamble; and a length of a vector in the second group of vectors is determined based on a time domain resource occupied by the preamble; determine a time domain offset estimation value based on the first group of vectors, and/or determine a frequency domain offset estimation value based on the second group of vectors; and perform frequency domain offset adjustment and/or time domain offset adjustment on a received signal based on the frequency domain offset estimation value and/or the time domain offset estimation value. In this implementation, in a vector corresponding to a preconfigured generation parameter of the vector, a length of the vector is determined based on a frequency domain resource occupied by a preamble signal, and/or the length of the vector is determined based on a time domain resource occupied by the preamble signal. Therefore, the communication apparatus may perform time domain offset estimation and/or frequency domain offset estimation by using the vector corresponding to the preconfigured generation parameter of the vector, to perform time domain and frequency domain adjustment on a signal subsequently received in the random access process. This ensures random access efficiency and precision, to resolve an asynchronization problem in the random access process in which the preamble sequence generated by using the product of the K vectors is used.

In some possible implementations, the length of the vector in the first group of vectors satisfies at least one of the following conditions: the length of each vector in the first group of vectors is a factor of a quantity of subcarriers occupied by the preamble, and a product of the lengths of the vectors in the first group of vectors is the quantity of subcarriers occupied by the preamble; and/or the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble. In this implementation, precision of time domain offset estimation and/or frequency domain offset estimation can be improved.

In some possible implementations, at least one of the generation parameter of the K₁ vectors, the generation parameter of the K₂ vector sets, the generation parameters of the K vectors, or the generation parameters of the K vector sets is determined based on a cell ID. In this implementation, for the communication apparatus in different cells, the selected or determined K vectors are not completely the same. Further, preamble sequences generated by using products of the K vectors are also different. This can reduce interference between cells and improve quality and efficiency of communication performed by using the preamble.

In some possible implementations, before receiving the uplink control information, the transceiver unit 1620 is further configured to send configuration information. The configuration information includes generation parameters of the K vectors, and at least a part of the generation parameters of the K vectors are determined based on the uplink control information. After determining the PUCCH sequence, the processing unit 1610 is further configured to: decompose the PUCCH sequence to obtain the K vectors; and detect the K vectors separately to obtain content transmitted through the uplink control information. In this implementation, efficiency of determining the K vectors by the terminal device can be improved. In addition, overheads of the configuration information are low, and consumption of communication resources is reduced. In addition, a capability and reliability of transmitting the uplink control information through the PUCCH sequence can be improved.

In some possible implementations, the preamble sequence or the PUCCH sequence is generated by using a Kronecker product of the K vectors. In this implementation, efficiency of obtaining the preamble sequence or the PUCCH sequence can be improved. This implementation is simple, and computing resources are saved.

In some possible implementations, the preamble or the uplink control information is received in an OFDM waveform or a DFT-s-OFDM waveform. In this implementation, the DFT-s-OFDM waveform is used, so that a PAPR of the preamble signal can be low, thereby improving transmission efficiency of the preamble.

It should be understood that for a specific process in which the units in the communication apparatus 1600 perform the foregoing corresponding steps, refer to the foregoing descriptions related to the network device or the RAN node in the related embodiments of the method 400, the method 500, the method 700, the method 900, the method 1100, or the method 1300. For brevity, details are not described herein again.

Optionally, the transceiver unit 1620 may include a receiving unit (module) and a sending unit (module), configured to perform the steps of receiving information and sending information by the network device in the embodiment of the method 400, the method 500, the method 700, the method 900, the method 1100, or the method 1300.

Further, the communication apparatus 1600 may further include a storage unit. The transceiver unit 1620 may be a transceiver, an input/output interface, or an interface circuit. The storage unit is configured to store instructions executed by the transceiver unit 1620 and the processing unit 1610. The transceiver unit 1620, the processing unit 1610, and the storage unit are coupled to each other. The storage unit stores the instructions. The processing unit 1610 is configured to execute the instructions stored in the storage unit. The transceiver unit 1620 is configured to send or receive the specific signal under driving of the processing unit 1610.

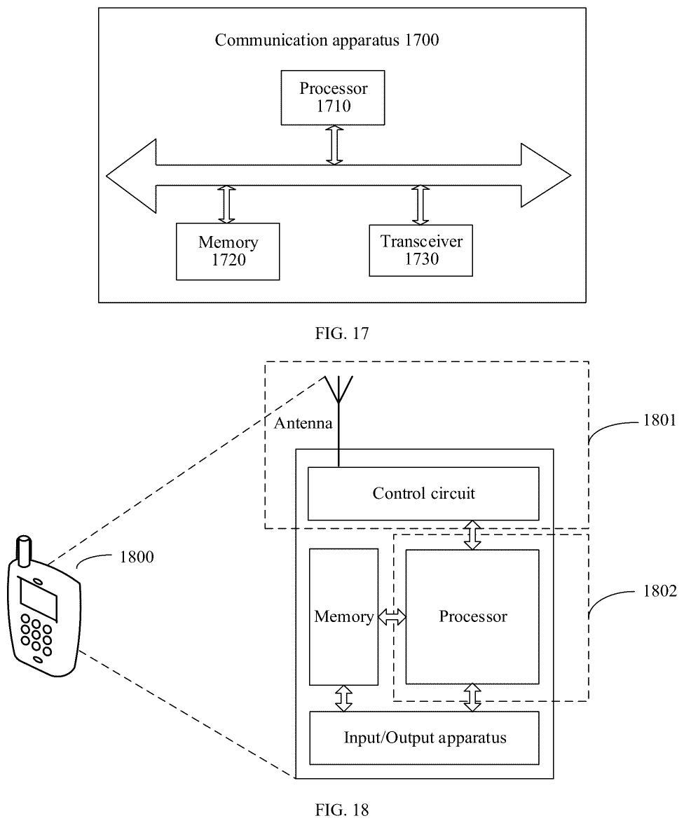

It should be understood that the transceiver unit 1620 may be the transceiver, the input/output interface, or the interface circuit. The storage unit may be a memory. The processing unit 1610 may be implemented by a processor. As shown in FIG. 17, a communication apparatus 1700 may include a processor 1710, a memory 1720, and a transceiver 1730. The transceiver 1730 may include a transmitter and a receiver.

The communication apparatus 1600 shown in FIG. 16 or the communication apparatus 1700 shown in FIG. 17 can implement the steps performed by the network device or the RAN node in the embodiment of the method 400, the method 500, the method 700, the method 900, method 1100, or the method 1300. For similar descriptions, refer to the descriptions in the foregoing corresponding methods. To avoid repetition, details are not described herein again.

It should be understood that, when the communication apparatus 1700 is a chip, the communication apparatus 1700 may include the processor 1710 and the transceiver 1730. The transceiver 1730 may correspond to the input and output interfaces. For example, the transceiver 1730 may include the input interface and the output interface. Alternatively, the transceiver 1730 may correspond to the interface circuit. The interface circuit is configured to output and/or input a signal.

It should be further understood that the communication apparatus 1600 shown in FIG. 16 or the communication apparatus 1700 shown in FIG. 17 may be a network device or a RAN node, or a network device or a RAN node may include the communication apparatus 1600 shown in FIG. 16 or the communication apparatus 1700 shown in FIG. 17.

It should be further understood that the network device in this disclosure may alternatively be a chip, a chip system, or a processor that supports the network device or the RAN node in implementing the method, or may be a logical node, a logical module, or software that can implement all or a part of functions of the network device or the RAN node.

It should be further understood that division into the units in the apparatus is merely logical function division. During actual implementation, all or some of the units may be integrated into one physical entity, or may be physically separated. In addition, all the units in the apparatus may be implemented in a form of software invoked by a processing element, or may be implemented in a form of hardware; or some units may be implemented in a form of software invoked by a processing element, and some units may be implemented in a form of hardware. For example, each unit may be a separately disposed processing element, or may be integrated into a chip of the apparatus for implementation. In addition, the unit may alternatively be stored in a memory in a form of a program to be invoked by a processing element of the apparatus to perform a function of the unit. The processing element herein may also be referred to as a processor, and may be an integrated circuit having a signal processing capability. In an implementation process, the steps in the foregoing methods or the foregoing units may be implemented by using a hardware integrated logic circuit in a processor element, or may be implemented in the form of software invoked by the processing element.

In an example, the units in any one of the foregoing apparatuses may be configured as one or more integrated circuits implementing the foregoing methods, for example, one or more application-specific integrated circuits (ASICs), or one or digital signal processors (DSPs), or one or more field programmable gate arrays (FPGAs). Alternatively, at least two of the integrated circuits are combined. For another example, when the unit in the apparatus is implemented in a form of scheduling a program by the processing element, the processing element may be a general-purpose processor, for example, a central processing unit (CPU) or another processor that may invoke the program. For still another example, the units may be integrated and implemented in a form of a system-on-a-chip (SoC).

FIG. 18 is a diagram of a structure of a terminal device 1800 according to this disclosure. The communication apparatus 1400 or the communication apparatus 1500 may be configured in the terminal device 1800. Alternatively, the communication apparatus 1400 or the communication apparatus 1500 may be the terminal device 1800. In other words, the terminal device 1800 may perform actions performed by the terminal device in the method 400, the method 500, the method 700, the method 900, method 1100, or the method 1300. Optionally, for ease of description, FIG. 18 shows only main components of the terminal device. As shown in FIG. 18, the terminal device 1800 includes a processor, a memory, a control circuit, an antenna, and an input/output apparatus.

The processor is mainly configured to: process a communication protocol and communication data; control the entire terminal device; execute a software program; and process data of the software program. For example, the processor is configured to support the terminal device in performing an action described in the foregoing method embodiments for information transmission. The memory is mainly configured to store the software program and the data. The control circuit is mainly configured to: convert a baseband signal and a radio frequency signal, and process the radio frequency signal. The control circuit and the antenna together may also be referred to as a transceiver, and are mainly configured to receive or send a radio frequency signal in an electromagnetic wave form. The input/output apparatus, for example, a touchscreen, a display, or a keyboard, is mainly configured to: receive data input by a user and output data to the user.

After the terminal device is powered on, the processor may read the software program in the storage unit, interpret and execute instructions of the software program, and process the data of the software program. When data needs to be sent wirelessly, the processor performs baseband processing on the to-be-sent data, and outputs a baseband signal to a radio frequency circuit. The radio frequency circuit performs radio frequency processing on the baseband signal, and sends, through the antenna, a radio frequency signal in an electromagnetic wave form. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

A person skilled in the art may understand that, for ease of description, FIG. 18 shows only one memory and one processor. An actual terminal device may include a plurality of processors and memories. The memory may also be referred to as a storage medium, a storage device, or the like. This is not limited in embodiments of this disclosure.

For example, the processor may include a baseband processor and a central processing unit. The baseband processor is mainly configured to process the communication protocol and the communication data. The central processing unit is mainly configured to: control the entire terminal device, execute the software program, and process the data of the software program. Functions of the baseband processor and the central processing unit are integrated into the processor in FIG. 18. A person skilled in the art may understand that the baseband processor and the central processing unit each may alternatively be independent processors, and are interconnected by using a technology like a bus. A person skilled in the art may understand that the terminal device may include a plurality of baseband processors to adapt to different network standards, and the terminal device may include a plurality of central processing units to enhance a processing capability of the terminal device, and components of the terminal device may be connected through various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the storage unit in a form of a software program, and the processor executes the software program to implement a baseband processing function.

For example, in this embodiment of this disclosure, the antenna having a transceiver function and the control circuit may be considered as a transceiver unit 1801 of the terminal device 1800, and the processor having a processing function may be considered as a processing unit 1802 of the terminal device 1800. As shown in FIG. 18, the terminal device 1800 includes the transceiver unit 1801 and the processing unit 1802. The transceiver unit may also be referred to as a transceiver, a transceiver machine, a transceiver apparatus, or the like. Optionally, a component that is configured to implement a receiving function in the transceiver unit 1801 may be considered as a receiving unit, and a component that is configured to implement a sending function in the transceiver unit 1801 may be considered as a sending unit. In other words, the transceiver unit 1801 includes the receiving unit and the sending unit. For example, the receiving unit may also be referred to as a receiver, a receive machine, a receiving circuit, or the like, and the sending unit may also be referred to as a transmitter, a transmit machine, a transmitting circuit, or the like.

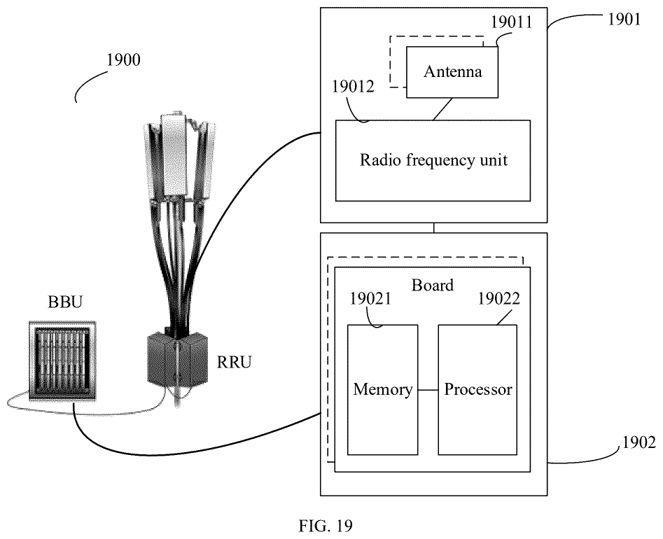

FIG. 19 is a diagram of a structure of a network device 1900 according to an embodiment of this disclosure. The network device 1900 may be configured to implement functions of the network device in the foregoing methods. The network device 1900 includes one or more radio units, such as a remote radio unit (RRU) 1901, and one or more baseband units (BBUs) (which may also be referred to as a digital unit, (DU)) 1902. The RRU 1901 may be referred to as a transceiver unit, a transceiver machine, a transceiver circuit, a transceiver, or the like, and may include at least one antenna 19011 and a radio frequency unit 19012. The RRU 1901 is mainly configured to: receive or send a radio frequency signal, and perform conversion between the radio frequency signal and a baseband signal, for example, send a signaling message in the foregoing embodiments to a terminal device. The BBU 1902 is mainly configured to perform baseband processing, control a base station, and the like. The RRU 1901 and the BBU 1902 may be physically disposed together, or may be physically disposed separately, namely, a distributed base station.

The BBU 1902 is a control center of the base station, may also be referred to as a processing unit, and is mainly configured to perform baseband processing functions such as channel coding, multiplexing, modulation, and spreading. For example, the BBU (processing unit) 1902 may be configured to control the base station to perform an operation procedure related to the network device in the foregoing method embodiments.

In an example, the BBU 1902 may include one or more boards. A plurality of boards may jointly support a radio access network (for example, an LTE system or a 5G system) of a single access standard, or may respectively support radio access networks of different access standards. The BBU 1902 further includes a memory 19021 and a processor 19022. The memory 19021 is configured to store instructions and data that are necessary. The processor 19022 is configured to control the base station to perform a necessary action, for example, configured to control the base station to perform an operation procedure related to the network device in the foregoing method embodiments. The memory 19021 and the processor 19022 may serve the one or more boards. In other words, a memory and a processor may be independently disposed on each board. Alternatively, a plurality of boards may share a same memory and a same processor. In addition, a necessary circuit may further be disposed on each board.

In a possible implementation, with development of a system-on-chip (SoC) technology, all or a part of functions of the part 1902 and the part 1901 may be implemented by using the SoC technology, for example, implemented by a base station function chip. The base station function chip integrates components such as a processor, a memory, and an antenna interface. A program of a related function of the base station is stored in the memory, and the processor executes the program to implement the related function of the base station. Optionally, the base station function chip can also read a memory outside the chip to implement the related function of the base station.

It should be understood that the structure of the network device shown in FIG. 19 is merely a possible form, but should not constitute any limitation on embodiments of this disclosure. In this disclosure, there may be a base station structure in another form in the future. For example, FIG. 3 shows another possible structure form of the network device (access network device).

It should be understood that, the processor in this embodiment of this disclosure may be a central processing unit (CPU), or the processor may be another general-purpose processor, a digital signal processor (DSP), an application specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory in this embodiment of this disclosure may be a volatile memory or a non-volatile memory, or may include the volatile memory and the non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), which is used as an external cache. By way of example but not limitative description, many forms of random access memories (random access memories, RAMs) may be used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or some of the foregoing embodiments may be implemented using software, hardware, firmware, or any combination thereof. When the software is used to implement the foregoing embodiments, the embodiments may be implemented completely or partially in a form of a computer program product. The computer program product includes one or more computer instructions or computer programs. When the computer instructions or the computer programs are loaded or executed on a computer, all or some of the procedures or functions according to embodiments of this disclosure are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

An embodiment of this disclosure further provides a communication system. The communication system includes the foregoing terminal device and the foregoing network device.

An embodiment of this disclosure further provides a computer-readable medium, configured to store computer program code. The computer program includes instructions used to perform any information transmission method provided in the foregoing embodiments of this disclosure. The readable medium may be a read-only memory (ROM) or a random access memory (RAM). This is not limited in embodiments of this disclosure.

This disclosure further provides a computer program product. The computer program product includes instructions. When the instructions are executed, a terminal device is caused to perform an operation of the terminal device corresponding to the foregoing method, or a network device is caused to perform an operation of the network device corresponding to the foregoing method.

An embodiment of this disclosure further provides a chip. The chip includes a processor, configured to execute a computer program or instructions in a memory, so that a communication device mounted with the chip performs any method provided in the foregoing embodiments of this disclosure.

Optionally, any communication apparatus provided in the foregoing embodiments of this disclosure may include the chip.

Optionally, the computer instructions are stored in a storage unit.

Optionally, the storage unit is a storage unit in the chip, for example, a register or a cache. Alternatively, the storage unit may be a storage unit that is in a terminal and that is located outside the chip, for example, a ROM or another type of static storage device that can store static information and instructions, or a RAM. The processor described above may be a CPU, a microprocessor, an ASIC, or one or more integrated circuits configured to control execution of a program for the foregoing information transmission method. The processing unit and the storage unit may be decoupled, are separately disposed on different physical devices, and are connected in a wired or wireless manner to implement respective functions of the processing unit and the storage unit, to support the system chip in implementing various functions in the foregoing embodiments. Alternatively, the processing unit and the memory may be coupled to a same device.

The terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification usually represents an “or” relationship between the associated objects.

The terms “uplink” and “downlink” in this disclosure are used to describe a data/information transmission direction in a specific scenario. For example, an “uplink” direction is usually a direction in which data/information is transmitted from a terminal to a network side, or a direction in which data/information is transmitted from a distributed unit to a central unit; and a “downlink” direction is usually a direction in which data/information is transmitted from a network side to a terminal, or a direction in which data/information is transmitted from a central unit to a distributed unit. It can be understood that “uplink” and “downlink” are merely used to describe a data/information transmission direction, without limiting specific start and end devices of data/information transmission.

In this disclosure, names may be assigned to various objects such as messages/information/devices/network elements/systems/apparatuses/actions/operations/procedures/concepts. It may be understood that the specific names do not constitute a limitation on the related objects. The assigned names may vary with factors such as scenarios, contexts, or usage habits. Understanding of technical meanings of technical terms in this disclosure should be determined mainly based on functions and technical effects embodied/performed by the technical terms in the technical solutions.

A person of ordinary skill in the art may be aware that the methods in embodiments of this disclosure may be all or partially implemented by using software, hardware, firmware, or any combination thereof. When the software is used to implement the methods, the methods in embodiments may be implemented completely or partially in a form of a computer program product. The computer program product includes one or more computer programs or instructions. When the computer programs or the instructions are loaded and executed on a computer, the procedures or functions in embodiments of this disclosure are all or partially executed. The computer may be a general-purpose computer, a dedicated computer, a computer network, or another programmable apparatus. The computer programs or the instructions may be stored in a computer-readable storage medium, or may be transmitted through the computer-readable storage medium. The computer-readable storage medium may be any usable medium accessible by the computer, or a data storage device, for example, a server, integrating one or more usable media.

It may be clearly understood by a person skilled in the art that, for convenient and brief description, for detailed working processes of the foregoing system, apparatus, and unit, refer to the corresponding processes in the foregoing method embodiments. Details are not described herein again.

In the several embodiments provided in this disclosure, it should be understood that the disclosed systems, apparatuses, and methods may be implemented in other manners. For example, the described apparatus embodiments are merely examples. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, that is, may be located in one position, or may be distributed on a plurality of network units. Some or all of the units may be selected based on an actual requirement to achieve the objectives of the solutions of the embodiments.

In addition, the functional units in embodiments of this disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to an existing technology, or a part of the technical solutions may be implemented in a form of a software product. The computer software product is stored in a storage medium and includes several instructions for instructing a computer device (which may be a personal computer, a server, a network device, or the like) to perform all or a part of the steps of the methods in embodiments of this disclosure. The foregoing storage medium includes a USB flash drive, a removable hard disk, a read-only memory (ROM), or random access.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. An information transmission method, wherein the method comprises:
generating a preamble sequence by using K vectors and sending a preamble based on the preamble sequence; or
generating a physical uplink control channel (PUCCH) sequence by using K vectors, and sending uplink control information based on the PUCCH sequence,
wherein K is an integer greater than or equal to 2.

2. The method according to claim 1, wherein the method comprises the generating the preamble sequence, and before generating the preamble sequence by using the K vectors, the method further comprises:
receiving configuration information, wherein the configuration information comprises a generation parameter of K₁ vectors and a generation parameter of K₂ vector sets;
generating the K₁ vectors based on the generation parameter of the K₁ vectors;
generating the K₂ vector sets based on the generation parameter of the K₂ vector sets; and
selecting one vector from each of the K₂ vector sets to obtain K₂ vectors, wherein the K vectors comprise the K₁ vectors and the K₂ vectors.

3. The method according to claim 1, wherein the method comprises generating the preamble sequence, and before generating the preamble sequence by using the K vectors, the method further comprises:
receiving configuration information, wherein the configuration information comprises generation parameters of the K vectors, and generating the K vectors based on the generation parameters of the K vectors, or
receiving configuration information, wherein the configuration information comprises generation parameters of K vector sets, generating the K vector sets based on the generation parameters of the K vector sets, and selecting one vector from each of the K vector sets to obtain the K vectors.

4. The method according to claim 2, wherein the K vectors comprise a first group of vectors or a second group of vectors; the first group of vectors comprises at least one of the K₁ vectors or at least one of the K vectors generated by using the generation parameters of the K vectors; the second group of vectors comprises at least one of the K₁ vectors or at least one of the K vectors generated by using the generation parameters of the K vectors; a length of a vector in the first group of vectors is determined based on a frequency domain resource occupied by the preamble; and a length of a vector in the second group of vectors is determined based on a time domain resource occupied by the preamble.

5. The method according to claim 4, wherein the K vectors comprise the first group of vectors and the length of the vector in the first group of vectors satisfies at least one of the following conditions: the length of each vector in the first group of vectors is a factor of a quantity of subcarriers occupied by the preamble, or a product of the lengths of the vectors in the first group of vectors is the quantity of subcarriers occupied by the preamble; or
the K vectors comprise the second group of vectors and the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble.

6. The method according to claim 2, wherein at least one of the generation parameter of the Kᵢ vectors and the generation parameter of the K₂ vector sets is determined based on a cell identity.

7. The method according to claim 1, wherein the method comprises the generating the PUCCH sequence and before generating the PUCCH sequence by using the K vectors, the method further comprises:
receiving configuration information, wherein the configuration information comprises generation parameters of the K vectors, and at least a part of the generation parameters of the K vectors are determined based on the uplink control information; and
determining the K vectors based on the generation parameters of the K vectors.

8. The method according to claim 1, wherein the sending the preamble based on the preamble sequence or sending the uplink control information based on the PUCCH sequence comprises:
performing a cyclic shift on the preamble sequence or the PUCCH sequence to obtain a cyclically shifted preamble sequence or a cyclically shifted PUCCH sequence; and
sending the preamble based on the cyclically shifted preamble sequence, or sending the uplink control information based on the cyclically shifted PUCCH sequence.

9. An information transmission method, wherein the method comprises:
receiving a preamble and determining a preamble sequence based on the preamble, wherein the preamble sequence is generated by using a product of K vectors, and K is an integer greater than or equal to 2, or
receiving uplink control information and determining a physical uplink control channel (PUCCH) sequence based on the uplink control information, wherein the PUCCH sequence is generated by using the product of K vectors, and K is an integer greater than or equal to 2.

10. The method according to claim 9, wherein the method comprises the receiving the preamble and before receiving the preamble, the method further comprises:
sending configuration information, wherein the configuration information is configured to be used to generate the preamble sequence, the configuration information comprises a generation parameter of K₁ vectors and a generation parameter of K₂ vector sets, the generation parameter of the K₁ vectors is configured to be used to generate the K₁ vectors, the generation parameter of the K₂ vector sets is configured to be used to generate the K₂ vector sets, the K₂ vector sets comprise K₂ vectors, and the K vectors comprise the K₁ vectors and the K₂ vectors.

11. The method according to claim 9, wherein the method comprises the receiving the preamble and before receiving the preamble, the method further comprises:
sending configuration information, wherein the configuration information is configured to be used to generate the preamble sequence, the configuration information comprises generation parameters of the K vectors or generation parameters of K vector sets, the generation parameters of the K vectors are configured to be used to generate the K vectors, the generation parameters of the K vector sets are configured to be used to generate the K vector sets and the K vector sets comprise the K vectors.

12. The method according to claim 10, wherein the method further comprises:
decomposing the preamble sequence to obtain the K vectors,
determining a time domain offset estimation value based on a first group of vectors, and performing time domain offset adjustment on a received signal based on the time domain offset estimation value, wherein the K vectors comprise the first group of vectors, the first group of vectors comprises at least one of the K₁ vectors or at least one of the K vectors generated by using the generation parameters of the K vectors, and a length of a vector in the first group of vectors is determined based on a frequency domain resource occupied by the preamble; or
determining a frequency domain offset estimation value based on a second group of vectors, and performing frequency domain offset adjustment on the received signal based on the frequency domain offset estimation value, wherein the K vectors comprise the second group of vectors, the second group of vectors comprises at least one of the K₁ vectors or at least one of the K vectors generated by using the generation parameters of the K vectors, and a length of a vector in the second group of vectors is determined based on a time domain resource occupied by the preamble.

13. The method according to claim 12, wherein the method comprises the determining the time domain offset, and the length of the vector in the first group of vectors satisfies at least one of the following conditions: the length of each vector in the first group of vectors is a factor of a quantity of subcarriers occupied by the preamble, and a product of the lengths of the vectors in the first group of vectors is the quantity of subcarriers occupied by the preamble; or
the method comprises the determining the frequency domain offset, and the length of the vector in the second group of vectors satisfies at least one of the following conditions: the length of each vector in the second group of vectors is a factor of a quantity of time-domain symbols occupied by the preamble, and a product of the lengths of the vectors in the second group of vectors is the quantity of time-domain symbols occupied by the preamble.

14. The method according to claim 10, wherein at least one of the generation parameter of the K₁ vectors and the generation parameter of the K₂ vector sets.

15. The method according to claim 9, wherein the method comprises the receiving uplink control information, and before receiving the uplink control information, the method further comprises:
sending configuration information, wherein the configuration information comprises generation parameters of the K vectors, the generation parameters of the K vectors are used to generate the K vectors, and at least a part of the generation parameters of the K vectors are determined based on the uplink control information; and after determining the PUCCH sequence, the method further comprises:
decomposing the PUCCH sequence to obtain the K vectors; and
detecting the K vectors separately to obtain content transmitted through the uplink control information.

16. The method according to claim 9, wherein the received preamble sequence or PUCCH sequence is generated by using a Kronecker product of the K vectors.

17. The method according to claim 9, wherein the received preamble or uplink control information is received in an orthogonal frequency division multiplexing (OFDM) waveform or a discrete Fourier transform spread orthogonal frequency division multiplexing (DFT-s-OFDM) waveform.

18. A communication apparatus, comprising:
at least one processor in communication with a memory, the at least one processor configured, upon execution of the instructions of the memory, to perform operations, comprising:
generating a preamble sequence or a physical uplink control channel (PUCCH) sequence by using K vectors, wherein K is an integer greater than or equal to 2; and
sending a preamble based on the preamble sequence, or sending uplink control information based on the PUCCH sequence.

19. The communication apparatus according to claim 18, wherein, the operations further comprise:
receiving configuration information, wherein the configuration information comprises a generation parameter of K₁ vectors and a generation parameter of K₂ vector sets;
generating the K₁ vectors based on the generation parameter of the K₁ vectors;
generating the K₂ vector sets based on the generation parameter of the K₂ vector sets; and
selecting one vector from each of the K₂ vector sets to obtain K₂ vectors, wherein the K vectors comprise the K₁ vectors and the K₂ vectors.

20. The communication apparatus according to claim 18, wherein, the operations further comprise:
receiving configuration information, wherein the configuration information comprises generation parameters of the K vectors or generation parameters of K vector sets; and
generating the K vectors based on the generation parameters of the K vectors; or
generating the K vector sets based on the generation parameters of the K vector sets, and
selecting one vector from each of the K vector sets to obtain the K vectors.
